(19) United States
(12) Patent Application Publication
(10) Pub. No.: US 2026/0222718 A1
(43) Pub. Date: Jul. 30, 2026

(54) AUDIO SPEAKER SYSTEM

(71) Applicant: MERRY ELECTRONICS NORTH AMERICA INC., DOING BUSINESS AS SONAVOX MENA, Richmond Hill (CA)

(72) Inventor: Najeeb KHAN, Toronto (ON)

(21) Appl. No.: 19/145,258

(22) PCT Filed: Dec. 29, 2023
(86) PCT No.: PCT/CA2023/051774

§ 371 Date: Jul. 2, 2025

Related U.S. Application Data
(60) Provisional application No. 63/436,726, filed on Jan. 3, 2023.

(51) Int. Cl. H04R 1/02; H04R 1/28; H04R 9/02; H04R 9/06

(52) U.S. Cl. CPC H04R 1/026; H04R 1/2826; H04R 1/2857; H04R 9/022; H04R 9/025; H04R 9/063; H04R 2201/021; H04R 2201/34

(57) ABSTRACT

Embodiments are described herein relate to audio speaker systems including loudspeaker and subwoofer systems, assemblies and modules. In at least one example, an audio speaker system is disclosed comprising: a loudspeaker assembly extending a long a first longitudinal axis; and/or a subwoofer assembly extending along a second longitudinal axis. Each of the loudspeaker and subwoofer assemblies house one or more loudspeaker drivers and include one or more audio outlet openings.

### CROSS-REFERENCE TO RELATED APPLICATIONS

This application claims the benefit of priority to United States Provisional Application No. 63/436,726 filed on Jan. 3, 2023, the entire contents of which are incorporated herein by reference in its entirety.

### FIELD

Various embodiments are described herein that generally relate to audio systems, and more particularly, to audio speaker systems including loudspeaker and subwoofer systems, assemblies and modules.

### BACKGROUND

Audio systems are often deployed (e.g., installed) in various environments, including in home entertainment systems, outdoor venues, movie theater settings, automotive environments (e.g., interior, and exterior) and the like. In many cases, these audio systems include audio generating devices such as sound bars and subwoofer boxes.

To that end, it is often desired for audio systems to generate high quality “room filling” audio, with minimal noise and distortion. It is also preferred that audio systems have minimal visibility exposure within their environment to avoid detracting from the overall aesthetic of the surrounding setting.

### SUMMARY OF VARIOUS EMBODIMENTS

According to one broad aspect, there is disclosed a subwoofer module comprising: a enclosure extending between a first enclosure end and a second enclosure end, wherein the first enclosure end defines an audio outlet opening; an extended port defined within a port chamber wall extending within the enclosure, the extended port extending along a port length dimension between a first port end and at least one second port end, the first port end is an open end defining the audio outlet opening; at least one elongate cabinet located within the enclosure, and extending parallel to the extended port, for at least a portion of a length of the cabinet; one or more driver-receiving openings adapted to receive one or more speaker drivers, wherein the driver-receiving openings are formed in the port chamber wall, and extend between the port and the at least one elongate cabinet.

In at least one embodiment, the one or more driver-receiving openings receive one or more of a woofer or a subwoofer driver.

In at least one embodiment, the at least one elongate cabinet comprises two elongate cabinets located around the port chamber wall.

In at least one embodiment, the one or more driver-receiving openings comprise a first and a second driver-receiving opening, wherein, the first driver-receiving opening is located in the port chamber wall, and extends between the port and a first elongate cabinet, and the second driver-receiving opening is located in the port chamber wall, and extends between the port and a second elongate cabinet.

In at least one embodiment, the first and second driver-receiving openings are aligned along a common axis.

In at least one embodiment, the extended port includes two second ends.

In at least one embodiment, the enclosure is formed of two or more enclosure subparts which couple to form the enclosure.

In at least one embodiment, the two or more enclosure subparts are integrally molded subparts.

In at least one embodiment, the subwoofer module is connectable to one or more other subwoofer modules to form a subwoofer assembly.

In at least one embodiment, the subwoofer module is connected to another subwoofer module at the second enclosure end such that the audio outlet openings, of each subwoofer module, are directed in opposing directions along a longitudinal axis.

According to another broad aspect, there is disclosed a subwoofer assembly comprising one or more subwoofer modules.

According to another broad aspect, there is disclosed a loudspeaker driver comprising a housing extending between a first housing end and a second housing end, wherein the first housing end comprises an audio outlet opening; an elongated chamber defined within the housing, and extending along an extension axis between a first chamber end and a second chamber end, the first chamber end defining the audio outlet opening; and a translating member that translates within the elongated chamber along extension axis between an extended position and a retracted position.

In at least one embodiment, wherein, in the extended position, the translating member translates in the direction of the first chamber end, along extension axis, and in the retracted position, the translating member translates in the direction of the second chamber end, along extension axis.

In at least one embodiment, an end of the translating member comprises a cap which translates through the first chamber end between the extended and retracted positions.

In at least one embodiment, the driver further comprises at least one support member connected to each of an inner surface of housing, and the translating member.

In at least one embodiment, the at least one support member is disposed within the elongated chamber between an inner surface of housing, and the translating member.

In at least one embodiment, the at least one support member comprises at least one flexible rolling support member that rolls and unrolls as the translating member translates between the extended and retracted positions.

In at least one embodiment, the at least one flexible rolling support member comprises a pair of flexible rolling support members that are: (i) spaced apart along extension axis, and (ii) inverted in position relative to each other.

In at least one embodiment, the at least one support member is a surround member that surrounds the entire outer perimeter of the translating member.

In at least one embodiment, the loudspeaker driver is one of an active loudspeaker driver and a passive loudspeaker driver.

In at least one embodiment, the loudspeaker driver comprises an active loudspeaker driver and the loudspeaker driver further comprises: an extended housing portion for housing a magnet assembly; a heatsink comprising one or more elongate axial fins coupling the housing to the extended housing portion, wherein an axial opening separates the housing from the extended housing portion, and wherein a portion of the translating member is coupled to, or surrounded by a voice coil.

According to another broad aspect, there is disclosed a loudspeaker module comprising: a phase plug member comprising an audio inlet portion and an audio outlet portion, the audio outlet portion having a small cross-sectional area than the audio inlet portion, wherein the audio inlet portion is adapted to interface over an audio loudspeaker driver; and a waveguide member comprising: (i) a waveguide audio inlet area, (ii) one or more audio outlet openings, and (iii) one or more acoustic waveguide channels connecting the audio inlet area to the one or more audio outlet openings, wherein the waveguide audio inlet area interfaces over the audio outlet portion of the phase plug member, and the waveguide inlet area and audio outlet portion have similar cross-sectional areas.

In at least one embodiment, the waveguide audio inlet area comprises a plurality of inlet openings, the waveguide outlet openings comprise a plurality of outlet openings, and a plurality of waveguide channels connect the plurality of inlet openings to the plurality outlet openings.

In at least one embodiment, the plurality of outlet openings are arranged in an arrangement configuration.

In at least one embodiment, the arrangement configuration is one of a straight line, a cross, a plus-sign shape and a wave pattern.

In at least one embodiment, the one or more waveguide channels have a constant cross-sectional area along a respective length of the channel.

In at least one embodiment, the phase plug member is adapted to transform input audio, received at inlet portion, into a compressed energy state, at the outlet portion, and the waveguide member is adapted to maintain audio in the compressed energy state until the audio reaches the waveguide audio outlet openings.

In at least one embodiment, the each of the one or more audio outlet openings acts as a three-dimensional point source for audio expansion.

In at least one embodiment, the audio loudspeaker driver is a mid-range tweeter.

In at least one embodiment, the one or more waveguide channels are designed to extend over or around an object.

In at least one embodiment, the module further comprises a cabinet portion which at least partially receives a rear end of the loudspeaker driver.

According to another broad aspect, there is disclosed a loudspeaker assembly comprises one or more loudspeaker modules.

In at least one embodiment, the assembly extends along a longitudinal axis, and the loudspeaker modules are connected in a line along the longitudinal axis.

In at least one embodiment, the waveguide audio outlet openings, of each loudspeaker module, are oriented in a first direction.

In at least one embodiment, the loudspeaker assembly further comprises one or more up-firing speaker systems, wherein each up-firing speaker system includes one or more loudspeaker drivers directed at a upward angle from the first direction.

In at least one embodiment, the loudspeaker assembly further comprises an overhang portion that includes one or more acoustic waveguides.

According to another broad aspect, there is disclosed an audio speaker system comprising: a loudspeaker assembly extending a long a first longitudinal axis; and a subwoofer assembly extending along a second longitudinal axis, wherein each of the loudspeaker and subwoofer assemblies house one or more loudspeaker drivers and include one or more audio outlet openings.

In at least one embodiment, the loudspeaker assembly comprises one or more loudspeaker systems coupled along the first longitudinal axis.

In at least one embodiment, in an upright position, the loudspeaker systems either include: (i) loudspeaker drivers oriented along a horizontal axis that is orthogonal to the first axis; (ii) loudspeaker drivers oriented upwardly, at an angle to the horizontal axis.

In at least one embodiment, the subwoofer assembly includes a surface that extends along the second longitudinal axis, and the loudspeaker assembly (204) is coupled to the surface in a coupled state.

In at least one embodiment, in the coupled state, the first longitudinal axis of loudspeaker assembly is parallel to the second longitudinal axis of the subwoofer assembly.

In at least one embodiment, one or more rotatable coupling mechanisms connect the loudspeaker assembly to the subwoofer assembly.

In at least one embodiment, in the coupled state, the loudspeaker assembly is translatable relative to the subwoofer assembly in an axis orthogonal to the first or second longitudinal axis.

In at least one embodiment, in the coupled state, the subwoofer assembly is mountable behind an object, and only the audio outlet openings of the loudspeaker assembly are visible.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1A shows an example home entertainment setting which includes a speaker system,

FIG. 1B shows another example home entertainment setting which includes an audio speaker system, in accordance with embodiments herein;

FIG. 2A is a perspective view of an audio speaker system, according to an example embodiment;

FIG. 2B is a side elevation view of the audio speaker system of FIG. 2A;

FIG. 2C is an illustration of the audio speaker system of FIG. 2A, mounted behind a television;

FIG. 3A is a perspective view of an audio speaker system, according to another example embodiment;

FIG. 3B is a side elevation view of the audio speaker system of FIG. 3A;

FIG. 3C is an illustration of the audio speaker system of FIG. 3A, mounted behind a television;

FIG. 4A is a perspective view of an audio speaker system, according to still another example embodiment;

FIG. 4B is a side elevation view of the audio speaker system of FIG. 4A;

FIG. 4C is an illustration of the audio speaker system of FIG. 4A, mounted behind a television;

FIG. 5A is an elevation view of an example subwoofer assembly;

FIG. 5B is a first side perspective view of the subwoofer assembly of FIG. 5A

FIG. 5C is a second side perspective view of the subwoofer assembly of FIG. 5A;

FIG. 6A is a front side perspective view of an example subwoofer module;

FIG. 6B is a first rear side perspective view of the example subwoofer module of FIG. 6A;

FIG. 6C is a second rear side perspective view of the example subwoofer module of FIG. 6A;

FIG. 7A is a cross-sectional view of the subwoofer module of FIG. 6A, taken along the section line 7-7′ in FIG. 6A, according to an example embodiment;

FIG. 7B is a perspective view of the cross-sectional view of FIG. 7A;

FIG. 7C is a cross-sectional view of the subwoofer module of FIG. 6A, taken along the section line 7-7′ in FIG. 6A, according to another example embodiment;

FIG. 8A is a cross-sectional view of the subwoofer module of FIG. 6A, taken along the section line 7-7′ in FIG. 6A, according to still another example embodiment;

FIG. 8B is a perspective view of the cross-sectional view of FIG. 8A;

FIG. 9A is a partially exploded cross-sectional view of the subwoofer module of FIG. 6A, taken along the section line 7-7′ in FIG. 6A, according to still yet another example embodiment;

FIG. 9B is a perspective view of the cross-sectional view of FIG. 9A;

FIG. 9C is an elevation view of the cross-sectional view of FIG. 9A;

FIG. 10A is a perspective cross-sectional view of the subwoofer module of FIG. 6A, taken along the section line 7-7′ in FIG. 6A, according to an example embodiment;

FIG. 10B is an elevation view of the cross-sectional view of FIG. 10A;

FIG. 11A is a perspective view of an example design for an audio outlet opening for a subwoofer module;

FIG. 11B is a perspective view of another example design for an audio outlet opening for a subwoofer module;

FIG. 12 is an example un-assembled subwoofer module;

FIG. 13A is an example un-assembled subwoofer assembly;

FIG. 13B is an example assembled subwoofer assembly;

FIG. 13C is a cross-sectional view of the subwoofer assembly of FIG. 13B, taken along the section line 13C-13C′ in FIG. 13B, according to an example embodiment;

FIG. 14A is a perspective cross-sectional view of the subwoofer assembly of FIG. 13B, taken along the section line 13C-13C′ in FIG. 13B, according to another example embodiment;

FIG. 14B is an elevation view of the cross-sectional view of FIG. 14A;

FIG. 15A is a side perspective view of an example subwoofer module;

FIG. 15B is a cross-sectional view of the subwoofer module of FIG. 15A, taken along the section line 15B-15B′ in FIG. 15A, according to an example embodiment;

FIG. 15C is a cross-sectional view of a subwoofer assembly, taken along a section line similar to the section line 13C-13C′ in FIG. 13B, according to another example embodiment;

FIG. 15D is a cross-sectional view of a subwoofer module, taken along a section like similar to the section line 15B-15B′ of FIG. 15A, according to an example embodiment;

FIG. 15E is a cross-sectional view of a subwoofer assembly, taken along a section line similar to the section line 13C-13C′ in FIG. 13B, according to still another example embodiment;

FIG. 16A is a side elevation view of an example active loudspeaker driver;

FIG. 16B is a front side perspective view of the active loudspeaker driver of FIG. 16A;

FIG. 16C is a rear side perspective view of the active loudspeaker driver of FIG. 16A;

FIG. 17A is a perspective cross-sectional view of the active loudspeaker driver of FIG. 16A, taken along the section line 17A-17A′ in FIG. 16A;

FIG. 17B is a rear perspective view of an example flexible rolling support member;

FIG. 17C is a front side perspective cross-sectional view of the support member of FIG. 17B, taken along the section line 17C-17C′ in FIG. 17B;

FIG. 17D is a perspective view of an active loudspeaker driver, according to another example;

FIG. 17E is a perspective cross-sectional view of the active loudspeaker driver of FIG. 17D, taken along the section line 17E-17E′ in FIG. 17D;

FIG. 17F is a perspective view of an active loudspeaker driver, according to another example;

FIG. 17G is a perspective cross-sectional view of the active loudspeaker driver of FIG. 17F, taken along the section line 17G-17G′ in FIG. 17F;

FIG. 18A is a rear side elevation view of an example passive loudspeaker driver;

FIG. 18B is a perspective cross-sectional view of the passive loudspeaker driver of FIG. 18A, taken along the section line 18B-18B′ in FIG. 18A;

FIGS. 19A-19C illustrate various translation positions for a translating member located inside the active loudspeaker driver of FIG. 16A, and showing the translating member in an initial position (FIG. 19A), a retracted position (FIG. 19B) and an extended position (FIG. 19C);

FIGS. 19D-19F illustrate various translation positions for a translating member located inside the active loudspeaker driver of FIG. 17D, and showing the translating member in an initial position (FIG. 19D), a retracted position (FIG. 19E) and an extended position (FIG. 19F);

FIG. 20A is a perspective view of an example loudspeaker assembly;

FIG. 20B is a perspective view of the loudspeaker assembly of FIG. 20A, with a top cover removed;

FIG. 20C is a perspective view of the example loudspeaker assembly, as well as various systems and modules comprising the assembly;

FIG. 20D is a perspective view of another example loudspeaker assembly, as well as various systems and modules comprising the assembly;

FIG. 21 is a perspective cross-sectional view of an example loudspeaker module, taken along the section line 21-21′ of FIG. 20C;

FIG. 22A is an exploded top-down perspective view of an example loudspeaker module;

FIG. 22B is an exploded bottom-up perspective view of an example loudspeaker module;

FIG. 23A is a bottom-up perspective view of an example phase plug member;

FIG. 23B is a bottom plan view of the example phase plug member of FIG. 23A;

FIG. 23C is a top-down perspective view of the example phase plug member of FIG. 23A;

FIG. 23D is an enlarged view of an audio outlet portion of a phase plug member;

FIG. 23E is a perspective cross-sectional view of the phase plug member of FIG. 23A, taken along the section line 23E-23E′ in FIG. 23C;

FIG. 23F is a perspective cross-sectional view of the phase plug member of FIG. 23A, taken along the section line 23F-23F′ in FIG. 23E;

FIG. 23G is a perspective cross-sectional view of the phase plug member of FIG. 23A, taken along the section line 23G-23G′ in FIG. 23E;

FIG. 24A is a perspective view of an example waveguide member;

FIG. 24B is a side elevation view of the example waveguide member of FIG. 24A;

FIG. 24C is a bottom plan view of the example waveguide member of FIG. 24A;

FIG. 25A is a perspective cross-sectional view of the waveguide member of FIG. 24A, taken along the section line 25A-25A′ in FIG. 24A;

FIG. 25B is a perspective cross-sectional view of the waveguide member of FIG. 24A, taken along the section line 25B-25B′ in FIG. 24B;

FIG. 25C is a perspective cross-sectional illustration of the waveguide member of FIG. 24A, taken along the section line 25B-25B′ in FIG. 24B;

FIG. 25D is a perspective cross-sectional illustration of another example waveguide member, taken along a similar section line as section line 25B-25B′ in FIG. 24B;

FIG. 26A is a partial front perspective view of an example waveguide member;

FIG. 26B is a perspective view of another example waveguide member;

FIG. 26C is a perspective cross-sectional illustration of the waveguide member of FIG. 26B, taken along the section line 25C-25C′ in FIG. 26B;

FIG. 27 is a perspective view of an example audio speaker system in a partially unassembled state;

FIG. 28 is a cross-sectional view of a portion of an example audio speaker system, taken along the section line 28-28′ in FIG. 2B, and showing a coupling mechanism connecting a loudspeaker assembly to a subwoofer assembly;

FIG. 29 is a perspective view of an example audio speaker system, and showing the loudspeaker assembly in a translated position relative to the subwoofer assembly;

FIG. 30A is a front perspective view of an example loudspeaker assembly;

FIG. 30B is a rear perspective view of the example loudspeaker assembly of FIG. 30A;

FIG. 30C is an example loudspeaker assembly with a mounting bracket;

FIG. 30D is a rear view of the example loudspeaker assembly with a mounting bracket, as shown in FIG. 30C, and showing a close-up view of a mechanical translation mechanism;

FIG. 31A is a perspective view of an example subwoofer assembly; and

FIG. 31B is a perspective cross-sectional illustration of the subwoofer assembly of FIG. 31A, taken along the section line 31B-31B′ in FIG. 31A.

Further aspects and features of the example embodiments described herein will appear from the following description taken together with the accompanying drawings.

### DETAILED DESCRIPTION OF VARIOUS EMBODIMENTS

Embodiments described herein generally relate to audio systems, including loudspeaker and subwoofer systems, assemblies and modules.

### I. General Overview

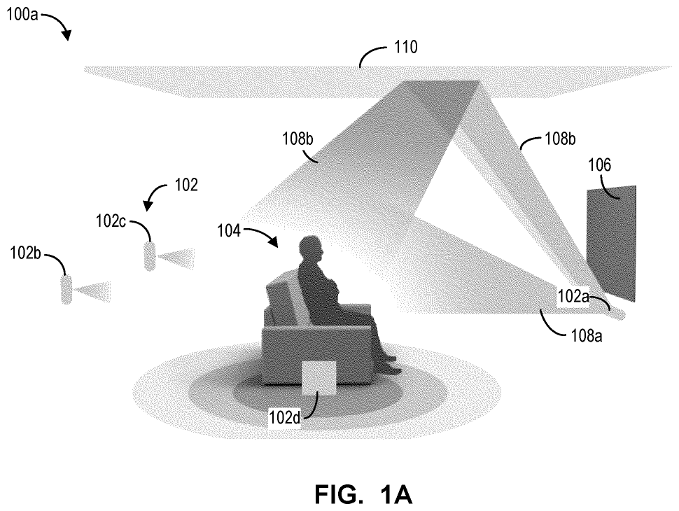

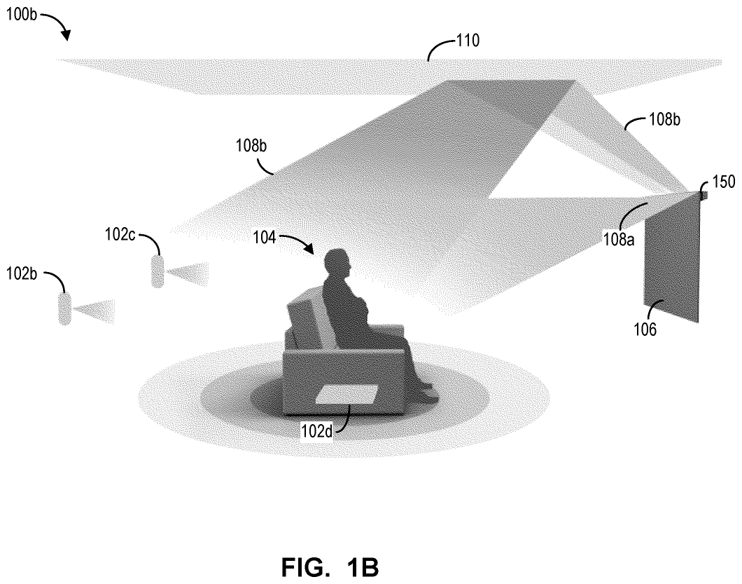

As discussed in the background, speaker systems are typically installed in environments that include home entertainment systems, movie theaters, and the like. FIG. 1A shows an example home entertainment environment (100a), which includes a speaker system (102).

As shown, one or more loudspeakers (102a)-(102c) and/or a subwoofer box (102d) are setup at different locations around a user (104). This provides the user with an immersive room-filling surround sound audio experience. Loudspeakers (102) can connect, for example, to a television (106)—e.g., a wall-mounted television (106)—to provide the audio output for a televised program.

In many cases, speaker system (102) includes a conventional sound bar (102a). Sound bar (102a) directs audio (108a) at the user (104). More advanced sound bars (102a) also include upward-firing speakers. These speakers direct audio (108b) upwardly such that audio (108b) is reflected of the room ceiling (110), and back towards the user (104). This also enhances the user's audio experience.

To that end, a significant drawback of conventional sound bar designs is that the sound bar (102a) must be placed far below, or in-front of the television (106).

For example, when the sound bar (102a) is wall-mounted—it must be mounted far below the television (106) to avoid blocking the upward-firing speakers. Alternatively, the sound bar (102a) must protrude out from the face of the television (106) (i.e., rather than being flush) so that the upward-firing speakers are again unblocked.

Alternatively, if the sound bar (102a) is not wall-mounted, then it requires dedicated furniture to support it above ground (e.g., a table).

In either case, placing of the sound bar (102a) below and/or in-front of the television (106)—and optionally supported by added furniture—is visually unappealing. Designers and homeowners often do not prefer visible speakers or unnecessary furniture detracting from the overall aesthetic of the surrounding environment.

Another disadvantage of the conventional sound bar design is that it does not include an integrated subwoofer. Subwoofers generate low frequency audio (e.g., 20 Hz to 200 Hz) and are included in speaker systems to achieve a full frequency range. In many cases, a subwoofer box (102d) is provided independently, as shown in FIG. 1A. However, a stand-alone subwoofer box (102d) again detracts from the overall room aesthetic.

In view of the foregoing, embodiments described herein generally relate to an audio speaker system which facilitates room filling surround sound, but that otherwise minimally detracts from the overall aesthetic of the surrounding environment.

Reference is now made to FIG. 1B, which shows another example home entertainment environment (100b). Home entertainment environment (100b) is a non-limiting example of an environment in which the audio systems, assemblies and modules described herein can be deployed, e.g., installed.

As shown, home entertainment environment (100b) is generally analogous to environment (100a), of FIG. 1A, but includes an audio speaker system (150) according to embodiments described herein. In some examples, the audio system (150) is configured as a sound bar.

As provided, the audio system (150) can include a loudspeaker assembly and an integrated subwoofer assembly. Accordingly, as contrasted to conventional sound bars, a separate subwoofer box is not required.

As shown in FIG. 1B, audio system (150) is adapted for mounting behind various objects. For example, audio system (150) is sized and dimensioned to fit behind a television (106), a couch or any other furniture piece. In this manner, the audio system (150) is mostly hidden, or nearly invisible to the room or venue occupant(s). In turn, the audio system (150) does not significantly detract from the overall aesthetic of the surrounding setting.

In more detail, audio system (150) can include an integrated subwoofer assembly, designed to fit in narrow or shallow spaces behind objects (e.g., between a wall and a wall-mounted television).

Further, audio system (150) can also include a loudspeaker assembly that minimally extends—from behind, below or around the object—to direct audio towards the listener. For example, in FIG. 1B, the loudspeaker assembly includes audio outlets that extend minimally above the television (106), to direct audio (108a) at the user (104).

In some embodiments, loudspeaker assembly also includes upward-firing speakers that reflect sound (108b) off the room ceiling. This reflection is generated using the space behind, and above an object, such as a television (106), as shown. This mitigates the problem of needing to place a sound bar in front of, or significantly below, the television (106) so that the up-firing speakers are not blocked by the television (106).

To that end, despite a small and mostly invisible or hidden form factor—audio system (150) can still provide a loud dynamic, and room filling audio experience.

### II. Example Audio Speaker System

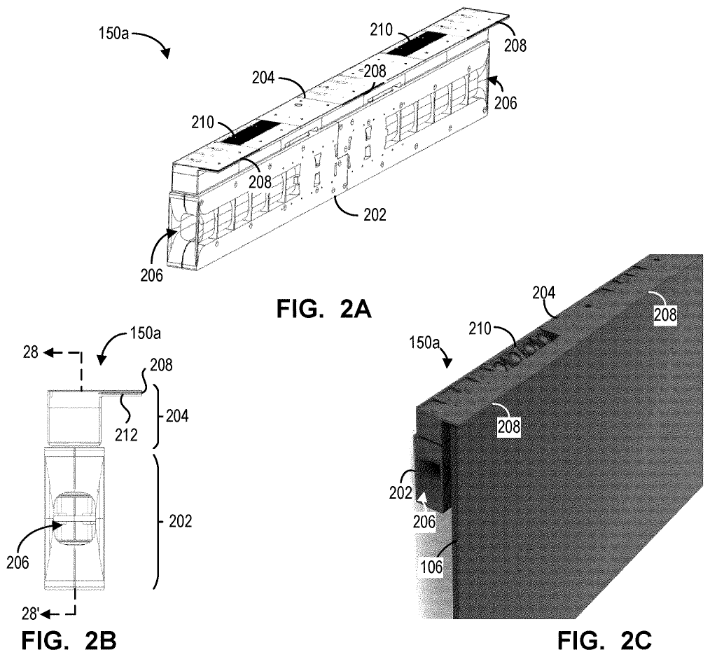

Reference is now made to FIGS. 2-4, which show various example embodiments of an audio speaker system (150), in accordance with embodiment herein.

### (a.) General Description.

As shown, the audio system (150) generally includes one or more of: (i) a subwoofer assembly (202); and/or (ii) a loudspeaker assembly (204). Each of the subwoofer (202) and loudspeaker (204) assemblies can house one or more speaker drivers (not shown).

In some examples, subwoofer (202) operates to generate low-pitched audio frequency outputs (e.g., 20 Hz to 200 Hz). In contrast, the loudspeaker assembly (204) can generate mid- to high-frequency audio outputs. In this manner, the audio system (150) can, in combination, generate audio along the full frequency spectrum.

As detailed below, subwoofer assembly (202) includes one or more subwoofer modules with audio output port(s) (206). In at least one example, the subwoofer assembly (202) is a modular combination of multiple subwoofer modules.

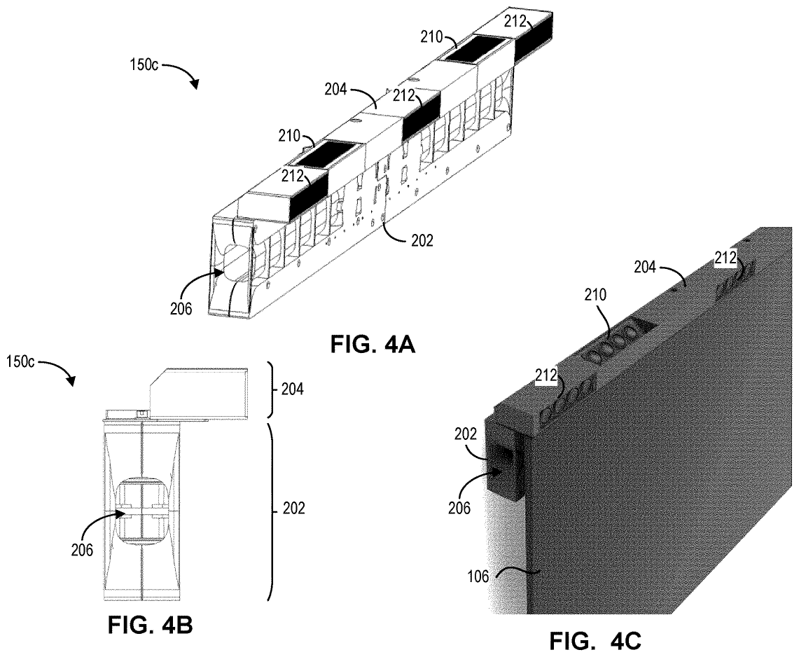

Loudspeaker assembly (204) includes one or more audio output openings (208), (210). These include one or more audio outlet apertures (208) (FIGS. 2-4). In some embodiments, the loudspeaker assembly (204) can also include upward-facing, or upward-firing speaker systems (210) (FIGS. 2 and 4).

The exemplified embodiments of FIGS. 2-4 illustrate an audio system (150) that includes both the loudspeaker and subwoofer assemblies (202), (204). Accordingly, the assemblies (202), (204) form an integrated audio system (150). For example, in an upright position, the loudspeaker assembly (204) is vertically stacked over, and coupled to the subwoofer assembly (202) (FIGS. 2B, 3B, 4B).

In the integrated and assembled state, the audio system (150) is designed to be mounted behind objects, and in locations that are not typically suited for audio sound bar placement. For instance, as exemplified in FIGS. 2-4, the audio system (150) is mountable in a small space behind a wall-mounted television set (106) and a mounting wall.

In this mounting position, the subwoofer assembly (202) is hidden out-of-view behind the television (106) (FIG. 2C). This is primarily owing to a unique slim, elongated and shallow depth design for the subwoofer assembly (202), as provided herein. The subwoofer assembly (202) can output audio from lateral audio output openings (206), which are unobstructed.

Additionally, the loudspeaker assembly (204) may include an overhang portion (212), which can rest overtop or around the television (106) or any other object (FIGS. 2D, 3C and 4C). The overhang portion (212) can include audio outlet openings (208) to direct audio towards the user.

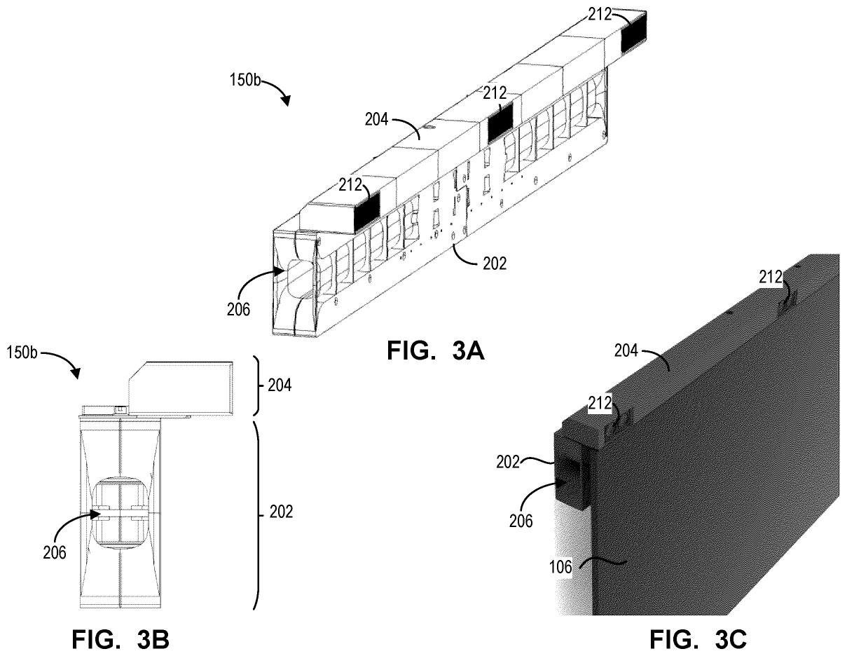

In at least one example, the loudspeaker assembly (106) uses “micro-apertures” for the audio outlet openings (208). In this manner, the overhang portion (212) is barely visible when rested over an object (see e.g., audio system (150a) in FIG. 2C). In other examples, the loudspeaker assembly (204) includes normal audio outputs (FIGS. 3C and 4C).

While the illustrated embodiments show the audio system (150) mounted behind and above a television, it will be appreciated that the audio system (150) can be mounted behind any object, and in any other position or orientation. In some examples, the disclosed systems can be used in automotive applications, as well.

In some examples, the subwoofer and loudspeaker assemblies (202), (204) can also be uncoupled. Accordingly, the two assemblies can be disposed in different spatial positions in an environment, e.g., a room.

In still other examples, the audio system (150) may not necessarily include both the subwoofer and loudspeaker assemblies (202), (204), but may only include only one of the assemblies.

### III. Example Subwoofer Assembly

The following is a description of a subwoofer assembly (202) that may be used by itself or in any combination or sub-combination with any other feature or features described herein. For example, the example subwoofer assembly (202) can be used in conjunction with the loudspeaker assembly (204).

As described below, the disclosed subwoofer assembly (202) is configured with a slim, or ultra slim design. In this manner, the subwoofer assembly (202) is adapted to be discretely mounted in narrow spaces, such as behind a television (106) or any other object (FIGS. 2-4). This is contrasted to conventional subwoofer enclosures, which are boxed shape and must be placed somewhere in the room, thereby detracting from the overall aesthetic of the surrounding environment.

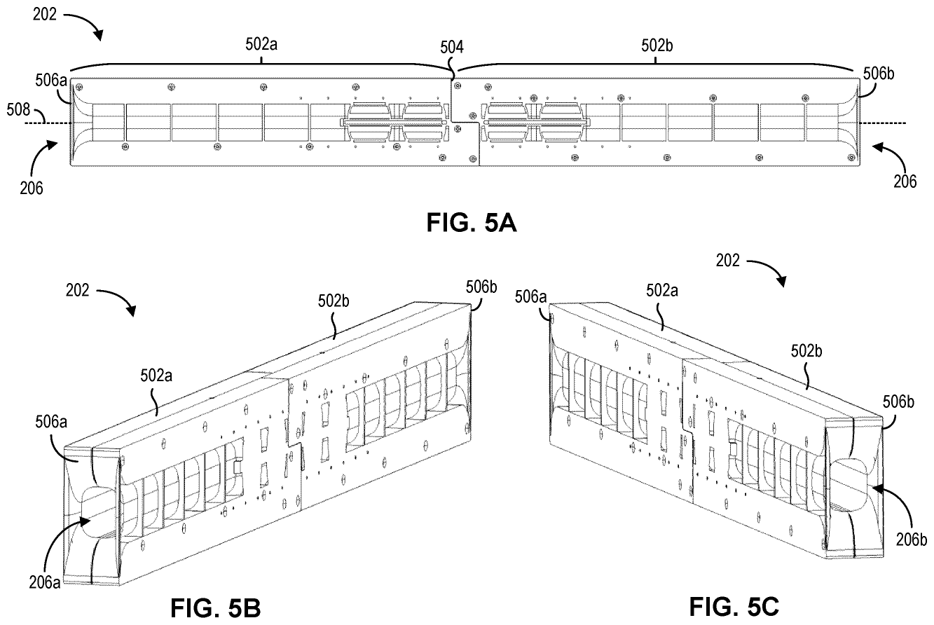

Reference is now made to FIGS. 5A-5C, which show an example subwoofer assembly (202).

As shown, the subwoofer assembly (202) includes one or more subwoofer modules (502). As explained, each subwoofer module (502) can house one or more loudspeaker drivers (e.g., woofers or subwoofers), which generate audio output.

In at least one example, the subwoofer modules (502) are modular units that are connectable to form the subwoofer assembly (202). In other examples, the subwoofer modules (502) are integrally molded with each other, to form assembly (202). The subwoofer assembly (202) can be formed of any number of connected subwoofer modules (502)

FIG. 5A exemplifies a subwoofer assembly (202) formed of two coupled subwoofer modules (502a), (502b). The subwoofer modules (502a), (502b) are connected together at the interconnection interface (504).

In the exemplified embodiment, the subwoofer modules (502a), (502b) are connected together along a longitudinal axis (508). In this manner, the subwoofer assembly (202) extends along the longitudinal axis (508), between a first end (506a) and a distal, second end (506b).

As noted previously, the exemplified elongated and shallow width design of the subwoofer assembly (202) (FIG. 5A) allows the assembly to be placed in narrow and elongate spaces behind objects (e.g., between a wall and a long television), while being hidden out-of-view. This is contrasted to conventional, large and bulky subwoofer boxes.

In this example, the first and second ends (506a), (506b), of subwoofer assembly (202), are open ends comprising audio output openings (206a), (206b). In use, the subwoofer assembly (202) can emit audio from either audio opening (206a), (206b). Each audio output opening (206a), (206b) may be associated with a separate subwoofer module (502).

In this configuration, the two audio outputs (206a), (206b) are oriented to face in opposing directions, i.e., along longitudinal axis (508). An appreciated advantage of this design is it allow the subwoofer assembly (202) to be mounted behind objects, without obstructing the subwoofer audio output.

For example, if mounted horizontally behind a television (106), the audio outputs (206) are directed to the left and right. In this manner, the audio outputs (206) are not blocked by the rear of the television (106), or an adjacent wall. This is contrasted to conventional subwoofer boxes, which can only direct audio forwardly or rearwardly. Further, as the audio outputs (206) are directed away from the user, port noise is also not directed towards the listener.

A further advantage of the exemplified design is that the longitudinally spacing between the audio outputs (206) generates significantly smoother room response with low standing waves. Room modes are excited differently by each audio outlet (206) of the subwoofer assembly (202), and tend to not constructively or destructively cause large peaks or dips in the room response in a variety of seating positions.

In disclosed embodiments, the subwoofer assembly (202) can have a scalable size. This can allow the assembly to accommodate objects of different widths and dimensions. For example, the exemplified subwoofer assembly (202) can be adjusted to have wider spacing between two audio output ports (206).

In addition to horizontal mounting, the exemplified subwoofer assembly (202) can also have any other suitable mounting orientation. For example, the subwoofer assembly (202) can be oriented vertically to emit audio vertically upwardly and downwardly. Further, as explained below, the subwoofer assembly (202) can include any other number of subwoofer modules (202), connected and mounted in any desired orientation.

The subwoofer module (502) is now described in greater detail, below.

### (III.ii) Example Subwoofer Module

The following is a description of a subwoofer module (502). The subwoofer module (502) can be used as a stand-alone device. For example, a subwoofer assembly (202) can comprise only a single subwoofer module (502). In other examples, the subwoofer module (502) can be combined with other subwoofer modules (502) to form a subwoofer assembly (202), comprising multiple subwoofer modules (502).

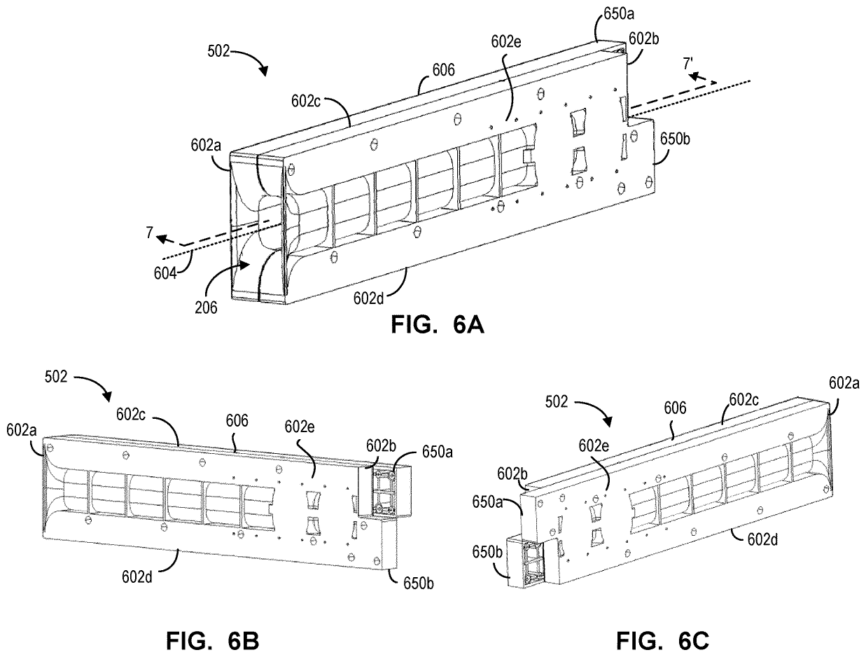

A general description of the subwoofer module (502) is now provided herein with reference to FIGS. 6-8.

As shown in FIGS. 6A-6C, subwoofer module (502) may include a housing or enclosure (606). Enclosure (606) retains various electrical and mechanical components.

Enclosure (606) extends between a first “front” enclosure end (602a) and a distal, second “rear” enclosure end (602b) (FIGS. 6A-6C). First end (602a) is at least partially open, and includes the audio outlet opening (206). In at least one example, the enclosure (606) includes more than one audio outlet opening (206), formed along various surfaces of the enclosure (606). Second end (602b) may be a closed end.

Enclosure (606) may also include a top side (602c), an opposing bottom side (602d) and one or more lateral surfaces (602e).

Reference herein to “top”, “bottom”, “front” and “rear” are only provided for ease of explanation, and it is understood that the module (502) is not limited to any particular orientation.

While the enclosure (606) is exemplified as being fully enclosed on all sides (i.e., except for outlet opening (206))—this is not necessarily a limiting feature of the subwoofer module (502).

In the exemplified embodiment, enclosure (606) extends along a longitudinal axis (604), and in linear fashion, between the first and second ends (602a), (602b). However, in other examples, the enclosure (606) may have other designs, including curved or arcuate designs.

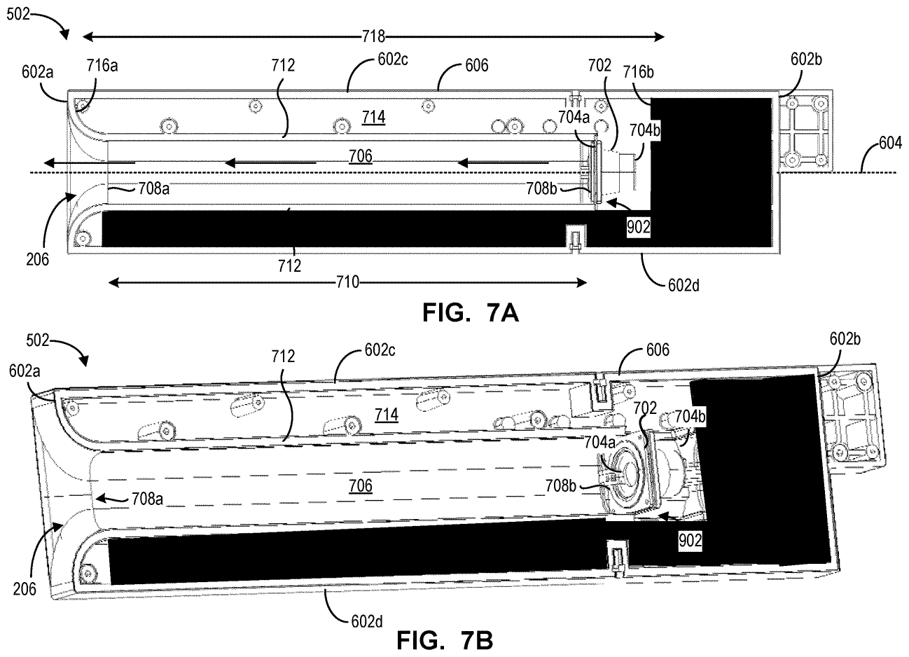

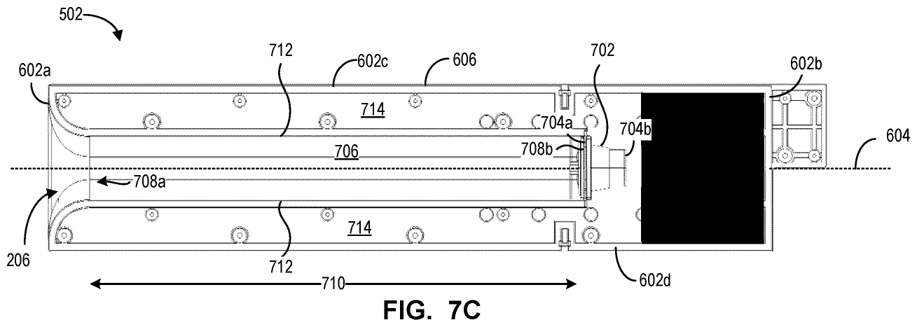

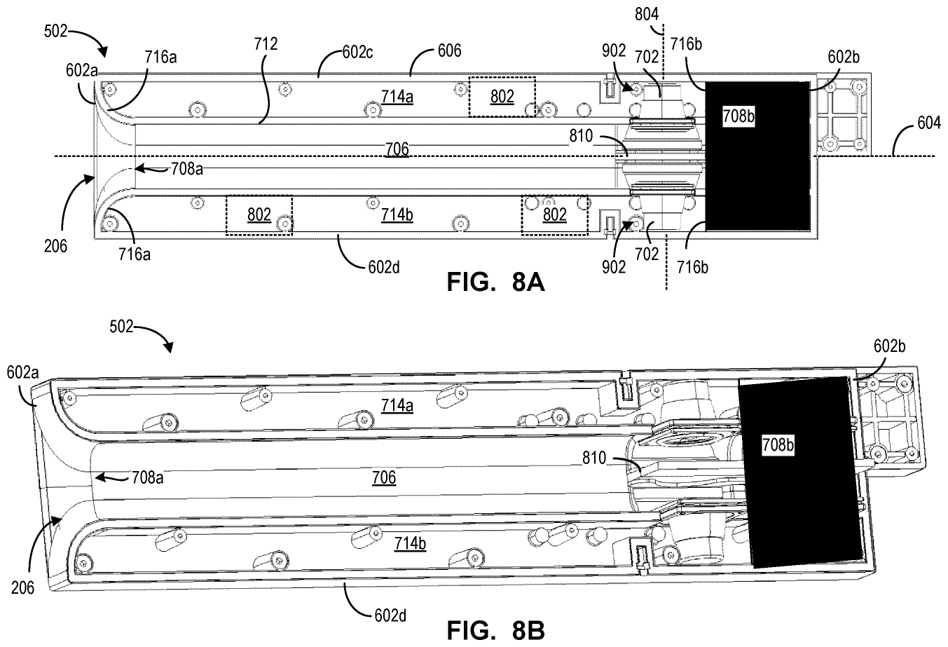

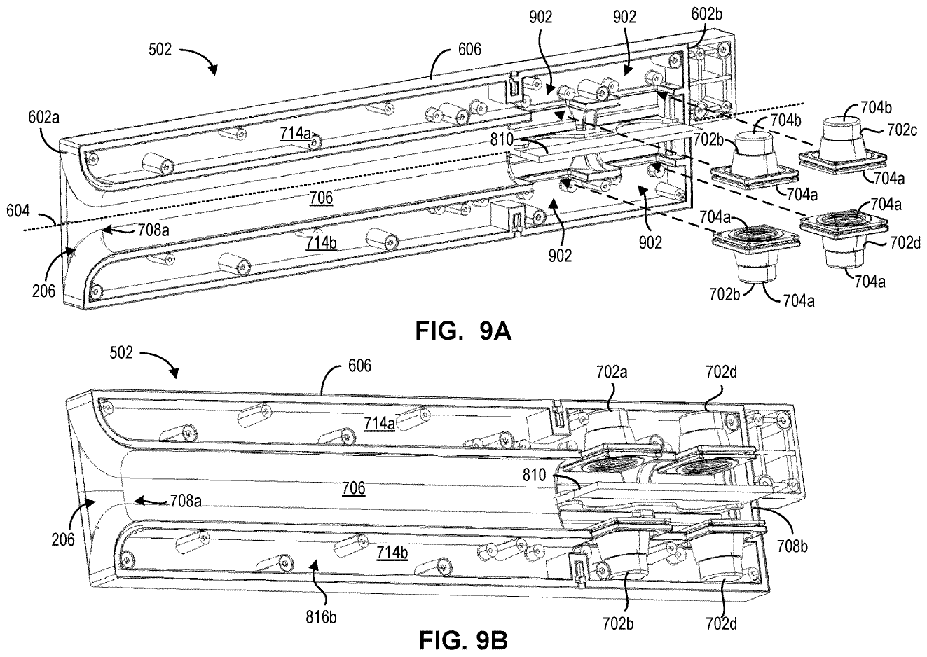

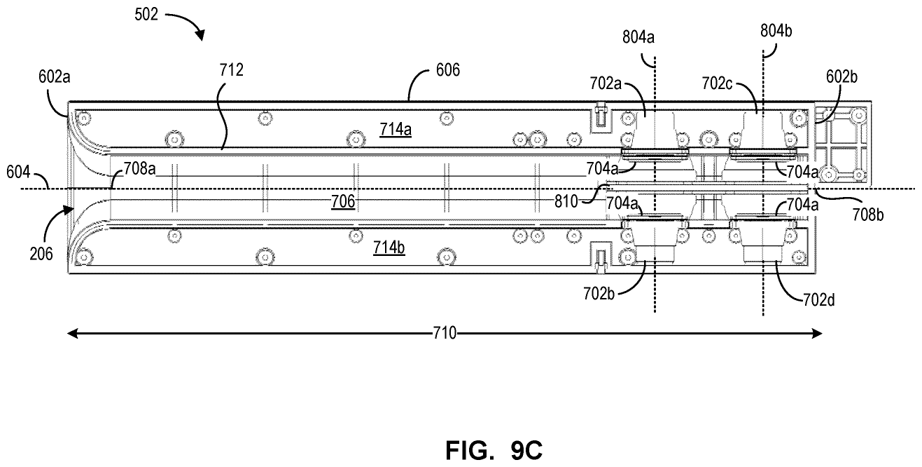

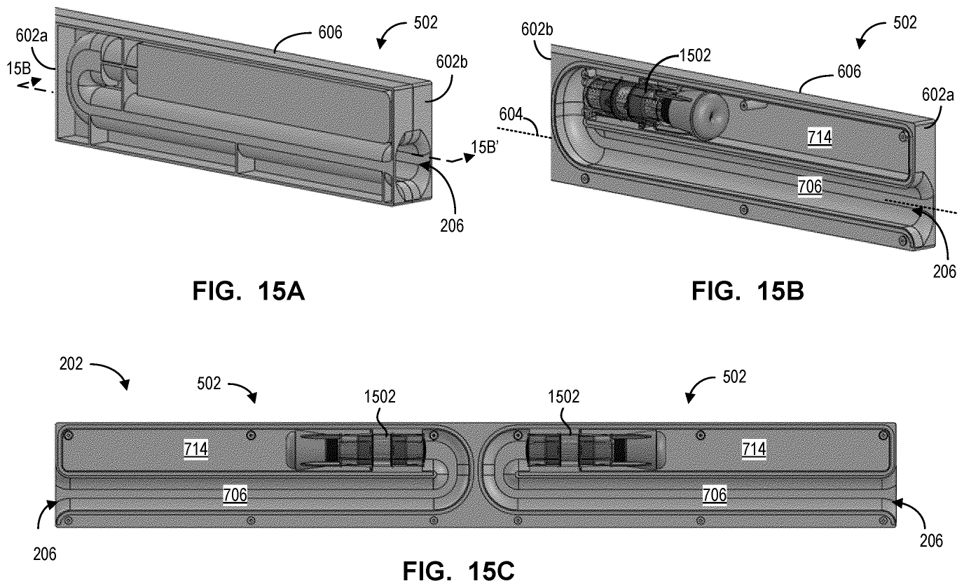

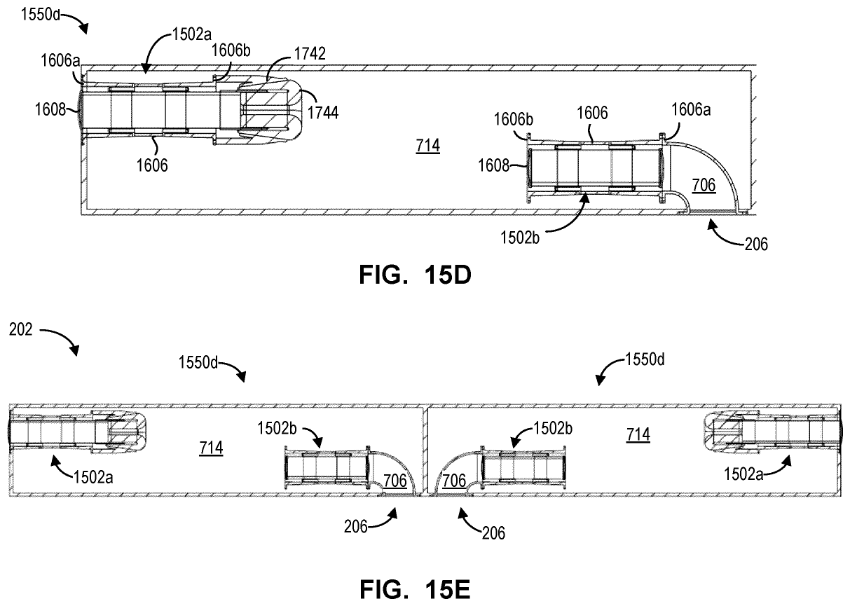

As shown in FIGS. 7-9, enclosure (606) houses any number of speaker drivers (702a)-(702d). For instance, enclosure (606) can house one speaker driver (FIGS. 7 and 15), two speaker drivers (FIG. 8), three speaker drivers (not shown), four speaker drivers (FIG. 9) or otherwise any number or plurality of speaker drivers.

As known in the art, speaker drivers (702) generate the audio output for the subwoofer module (502). Speaker drivers (702) can include woofers and/or subwoofers. Each speaker driver (702) may include a front end (704a) and an opposed rear end (704b) (FIGS. 7A and 7B). The front driver end (704a) may include a moving cone, dome or the like, to emit audio. Audio which is generated by the speaker drivers (702) travels inside the enclosure (606), and exits the audio outlet opening (206).

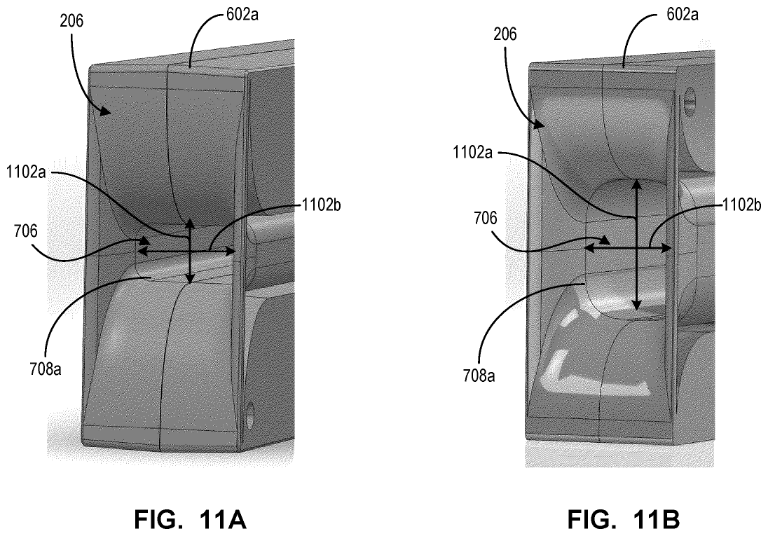

In at least one example, audio outlet opening (206) has a curved or arcuate finish (FIGS. 11A and 11B). This design may reduce or minimize wind noise generated from output sound or audio.

### (a.) Extended Channel Port (706).

As exemplified, enclosure (606) can also include an extended channel port (706).

Extended channel port (706) connects speaker drivers (702), to the subwoofer audio outlet (206). In this manner, audio generated by the speaker drivers (702) travels through the port (706), and exits the subwoofer module (502) via the outlet opening (206) (see e.g., arrows in FIG. 7A).

As shown in FIG. 7A, port (706) is formed as a hollow channel (or partially hollow chamber), within a port chamber wall (712). Port chamber wall (712) at least partially extends within enclosure (606). To that end, port chamber wall (712) may be separated and/or integrally formed, with the enclosure (606).

In more detail, port (706) extends by a port length (710), between a first port end (708a) and at least one second port end (708b) (FIGS. 7A and 7C).

First port end (708a) is proximal, and in communication with, the subwoofer's outlet opening (206). Second port end (708b) is distally located from the outlet opening (206). In this fashion, port (706) extends along, at least a portion, of the length of the subwoofer module (502).

As further shown, port chamber wall (712) includes at least one driver-receiving opening (902), formed there-through (see e.g., FIG. 9A). Driver-receiving opening(s) (902) retain the speaker drivers (702).

In FIG. 7A, the driver opening (902) is formed at the second port end (708b). In other cases, the openings (902) may be formed at any other position along a lateral surface of the port chamber wall (712) (FIG. 9A).

When a speaker driver (702) is mounted inside a driver-receiving opening (902), the speaker driver (702) is oriented with its front end (704a) facing into the extended port (706). In this position, audio generated by the speaker driver (702) is emitted into port (706), and carried through the port (706) to the outlet opening (206).

Extended port (706) can have various design configurations. For instance, in the exemplified embodiment, port (706) has a generally linear configuration. In other examples, at least a portion of the port length (710) may have a curved or arcuate design.

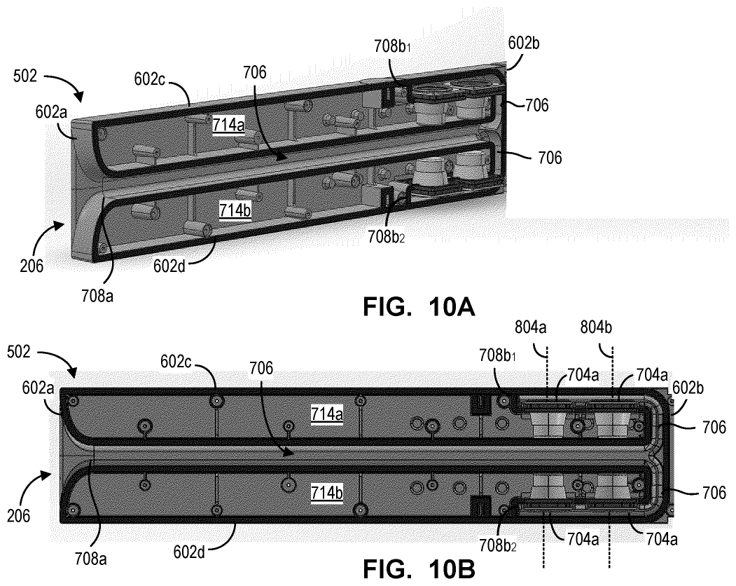

FIGS. 10A-10B and 15B exemplify a partially arcuate design for the port (706). In this example, port (706) curves towards the top and/or bottom surfaces (602c), (602d) of the enclosure (606). This curving can occur near the second port end (708b). Curving the port (706) in this manner can help elongate the port length (710), without otherwise increasing the size of the enclosure (606) (e.g., for frequency tuning).

In some examples, port (706) can also separate, or bifurcate, into two or more second port ends (708b₁), (708b₂) (FIGS. 10A-10B). As explained below, this configuration can accommodate curving of the port (706), as well as different placement of the speaker drivers (702). It is also possible for port (706) to separate, or bifurcate into one or more first port ends (708a) (not shown).

In the illustrated embodiment, port (706) has a generally rectangular cross-sectional shape (FIGS. 11A, 11B). The rectangular, cross-sectional profile is defined by a selected height dimension (1102a) and width dimension (1102a).

In at least one example, as port (706) effectively functions as a Helmholtz resonator—adjusting the cross-sectional area of the port (706) may necessitate modifying the port length (710). For example, a smaller port (706) may require a longer port length dimension (710) to achieve desired frequency tuning.

In other examples, port (706) may have any other suitable cross-sectional design, shape and/or size. This shape and/or size can be uniform, or variable, along the port length (710). For example, in FIG. 10B, the portion of the bi-furcating curved port (706) has a small cross-sectional area than then the remaining portion of port (706). In some examples, the cross-sectional area is varied in this manner to also achieve certain benchmark performance properties for the subwoofer module (502).

### (b.) Sealed Cabinets (714).

Enclosure (606) also includes one or more elongated cabinets (714) (FIG. 7A). In some example, cabinets (714) are sealed, or substantially sealed.

More generally, cabinets (714) define an, at least partially, hollow volume within enclosure (606). As explained, in some examples, cabinets (714) are isolated (e.g., fluidically isolated) from the extended port (706).

As best shown in FIGS. 7A-7C and 9A, within enclosure (606)—driver-receiving openings (902) separate cabinets (714) from the extended port (706). Accordingly, when speaker drivers (702) are mounted inside the driver openings (902), the drivers (702) function to also separate the cabinets (714) from the extended port (706).

As known in the art, in this configuration, the sealed cabinets (714) effectively function as an acoustic suspension enclosure. The length, dimension and volume of the sealed cabinets (714) can be adjusted with a view to desired frequency tuning properties of the subwoofer module (502).

When a speaker driver (702) is mounted inside a driver-receiving opening (902)—the driver is oriented to direct the rear driver end (702b) towards or into the cabinet (714), and the front driver end (704a) towards or into the extended port (706) (as mentioned previously).

In at least one example, a barrier member (708c) (e.g., seal) is provided around the speaker driver (702) to further isolate the port (706) from the sealed cabinet (714) when the speaker driver (702) is in the mounted position.

As explained below, cabinets (714) can house various electronic hardware required to drive the speaker drivers (702). For instance, this can include various active amplification hardware.

Any number of sealed cabinets (714) can be provided inside enclosure (606). In many cases, the number of sealed cabinets (714) is based on the location and positioning of the speaker drivers (702). For example, the subwoofer module (502) can include a single sealed cabinet (714) (FIGS. 7A-7C), or two separate sealed cabinets (714a), (714b) (FIGS. 8-10).

### (c.) Arrangement of Extended Port and Sealed Cabinets.

A unique design feature of the subwoofer module (502) is that the sealed cabinet(s) (714) extend longitudinally, and generally in parallel with the extended port (706). For instance, in each of FIGS. 7-10, cabinets (714) extend along, at least a portion of the length of the extended port (706), i.e., along axis (604).

As used herein, parallel may not only refer to a linear parallel configuration, but can also refer to any other configuration where the port (706) and cabinets (714) extend in the same direction. For instance, this can include curved parallel configurations, whereby the sealed cabinet can also, at times, curve with the extended port (706).

In more detail, in FIG. 7A, sealed cabinet (714) extends between a front end (716a) and rear end (716b), to define a cabinet length (718). Cabinet length (718) extends along axis (604), substantially parallel to the port length (710).

Similarly, in FIGS. 8-10, two separate cabinets (714a), (714a) are included inside the enclosure (606). Each cabinet (714) extends between a corresponding front cabinet end (716a) and rear, second cabinet end (716b) (see e.g. FIG. 8A). Each cabinet (714) extends between ends (716a), (716b) generally parallel to the port (706).

An advantage of the exemplified parallel configuration is to mitigate a drawback of existing subwoofer boxes. In conventional subwoofer boxes, it is difficult to design the port long enough to tune the subwoofer to the optimal frequency. In many cases, a long port must extend outside the subwoofer box.

However, in the exemplified designs, the cabinet volume (714) is simultaneously larger than a standard band-pass enclosure, but at the same time allows for a very long port that would normally not fit within a standard band-pass enclosure. This is because the cabinet volume extends in parallel with the port. In turn, this allows for a very low tuning frequency and a long port—which are not normally possible in combination in a typical band-pass enclosure.

In this manner, the parallel arrangement of the port (706) and sealed enclosure (714) facilitates a long, narrow design for the subwoofer module (502), which allows it to be mounted in small and narrow spaced, e.g., behind a television (106) and a mounting wall.

Additionally, it can be observed that the subwoofer module (502) does not include both a rear and front cabinets, which are used in conventional band-pass subwoofers. Rather, the subwoofer module (502) function only using a rear cabinet (714). This, in turn, also allows encapsulating the subwoofer module (502) into a smaller form factor enclosure.

To that end, sealed cabinets (714) may be disposed in any positional relation relative to the port (706). For example, in an upright position, the sealed cabinet (714) can extend above the port (706) (FIG. 7A), below the port (706), above and below the port (FIGS. 7C and 8-10) or even laterally to the port (706). It is also possible for a single sealed cabinet to extend in continuous fashion around the port (706) (FIG. 7C) (e.g., in a U-shape), e.g., to increase the cabinet volume. In cases where multiple cabinets (714) are used, the cabinets can be isolated from each other (FIGS. 8-10). Different designs can be used to accommodate different positions for the speaker drivers, as well as different performance characteristics for the subwoofer module (502) (e.g., based on desired cabinet volume).

### (d.) Speaker Drivers—Positioning, Orientation and Arrangement.

As noted previously, subwoofer module (502) can house one or more speaker driver (702) (e.g., multiple or a plurality of drivers).

The use of multiple small drivers (702) allows a shallow depth for the module (502) such that the subwoofer module (502) is mountable in locations that are traditionally not suitable for a subwoofer box, such as behind a television (106) or under or behind a couch.

As explained, speaker drivers (702) are mountable in the driver-receiving openings (902). Driver openings (902) are formed along the port chamber wall (712), and extend between the port (706) and a cabinet (714).

Speaker drivers (702)—retained in openings (902)—can either be permanently mounted within openings (902) (e.g., integrally molded), or otherwise connected in a removable manner.

Driver-receiving openings (902) can be located at various positions along the length of the port chamber wall (712). In FIGS. 7-10, the driver openings (902) are generally positioned at the second port end (708b). An advantage of this position is to allow the entire length of the port (706) to be used for conveying audio.

In other examples, the driver openings (902) can also be positioned anywhere along the extended port length (710) (see e.g., example location boxes (802) in FIG. 8A). In some examples, positioning the drivers (702) nearer the first port end (708a) is used for frequency tuning, e.g., by using a smaller length of the port (706).

In addition to having a variable position along the port length (710)—driver openings (912) can also have any suitable orientation. Different orientations are used to mount speaker drivers (702) in different orientation positions.

For example, in FIG. 7A-7C, the speaker driver (702) is mounted to face directly into the second port end (708b). For instance, the front and rear driver ends (704a), (704b) are aligned along the longitudinal axis (604). This configuration may be suitable where the subwoofer includes a single driver (702).

FIGS. 8-10 exemplify another configuration, where one or more speaker drivers (702) are mounted orthogonal to the extended port (706). For example, the front and rear driver ends (704a), (704b) are aligned along a traverse axis (804) (FIGS. 8A, 9C and 10B). Traverse axis (804) may be generally orthogonal to the longitudinal axis (604). This configuration can be suited for multiple speaker drivers (702), but can also be used for a single speaker driver.

In examples, where the speaker drivers (702) are oriented along the traverse axis (804) (FIGS. 8-10), drivers (702) may be mounted either upwardly or downwardly. If oriented upwardly (FIG. 10B), extended port (706) can curve to communicate with the front driver end (704a). As discussed previously, this orientation may be desirable to accommodate an extended port length (710). To that end, it will be understood that reference to “upwardly” and “downwardly” herein throughout is non-limiting, and is only used for ease of explanation.

In at least one example, where multiple speaker drivers (702) are used—the speaker drivers can be arranged in pairs. For example, in FIGS. 8A-8B, two speaker drivers (702a), (702b) are provided. The driver openings (902) are positioned opposite each other, across extended port (706), and along a common axis (804). Each speaker driver (702a), (702b) may be associated with a different sealed cabinet (714a), (714b). An advantage of this paired configuration is that vibrations from each driver (702) are cancelled by its matching pair.

In the example of FIGS. 8A-8B, speaker drivers (702) are oriented such that front driver ends (704a) face each other. In these examples, a divider (810) may be inserted within the extended port (706), and between the speaker pairs (FIGS. 8A-8B). Divider (810) can be used to absorb high frequency audio components.

As shown in FIGS. 10A-10B, the matching pair sets can also be configured such that each speaker driver (702) faces away from each other, i.e., the front driver end (704a).

Subwoofer module (502) can also include more than one matching pair set. For example, FIGS. 9A-9B show an embodiment using two matching pair sets (702a), (702b) and (702c), (702d). Each speaker pair can be disposed at a different location along the length of the extended port (706). That is, it is not necessary that the speaker pairs are located adjacently, as shown. Further, it is possible that each speaker pair is aligned along a different axis (804a), (804b).

In other examples, multiple speaker drivers (702) are provided, without necessarily being arranged in parallel and matching pairs.

### (e.) Enclosure (606).

Enclosure (606) may be formed of a single integrally molded part, or multiple subparts that are connectable. If formed of multiple subparts, enclosure (606) can be formed of any number of connectable subparts.

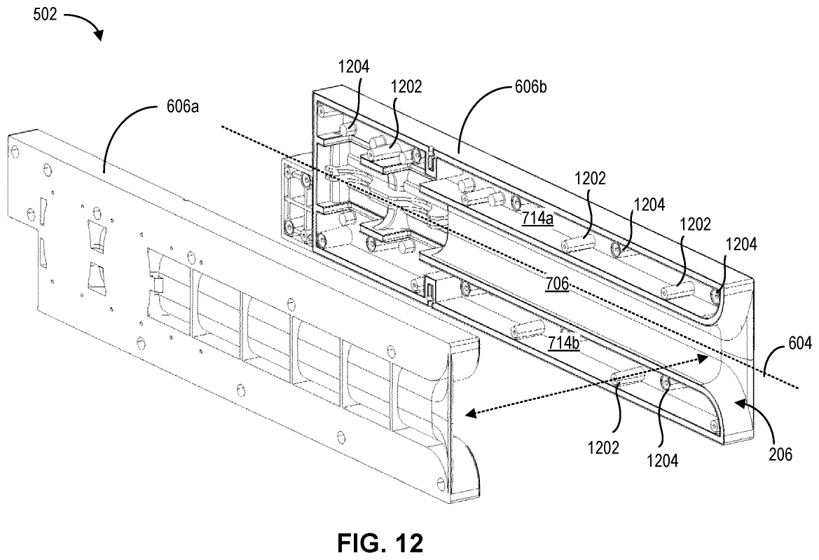

FIG. 12 shows an example enclosure (606) formed of two connectable enclosure subparts (606a), (606b). The two subparts (606a), (606b) are connected along an axis orthogonal to the longitudinal axis (604). Each subpart (606a), (606b) can include a portion of the enclosure (606). For example, each subpart (606a), (606b) can include an open half of the extended port (706) and the one or more sealed cabinets (714).

Any coupling mechanism known in the art can be used to connect and secure the enclosure subparts (606a), (606b), into the closed state. For example, a “pin-and-hole” coupling mechanism can be used to connect the subparts (606a), (606b). For instance, each sealed cabinet (714) can include one or more pins (1202) that are axially received into corresponding holes (1204) on the opposing part.

An advantage of using multiple subparts is that the subparts can be disassembled into an open state. Opening the subwoofer module (502) allows access to the drivers (702) (e.g., to change and maintain the drivers (702)), or otherwise to clean-out or repair the subwoofer module (502).

In at least one example, the subparts are each injected molded. Using injection molding to manufacture multiple coupled subparts can reduce overall manufacturing costs (e.g., as opposed to forming the enclosure (606) from a single part).

### (III.iii) Modular Combination of Subwoofer Modules

As discussed previously, a unique feature of the subwoofer module (502) is that it may be used in a modular and inter-connectable fashion with other subwoofer modules (502). Accordingly, multiple subwoofer modules (502) may be coupled together to form a subwoofer assembly (202) (FIGS. 5A-5C).

Any suitable coupling mechanism can be used to couple multiple subwoofer modules (502). In the exemplified embodiment, and as best shown in FIGS. 6B and 6C, the coupling mechanism can include a pair of connectors (650a), (650b). Connectors (650a), (650b) can each include male and female connector components. The connectors (650a), (650b) can extend longitudinally, from the second enclosure end (602b).

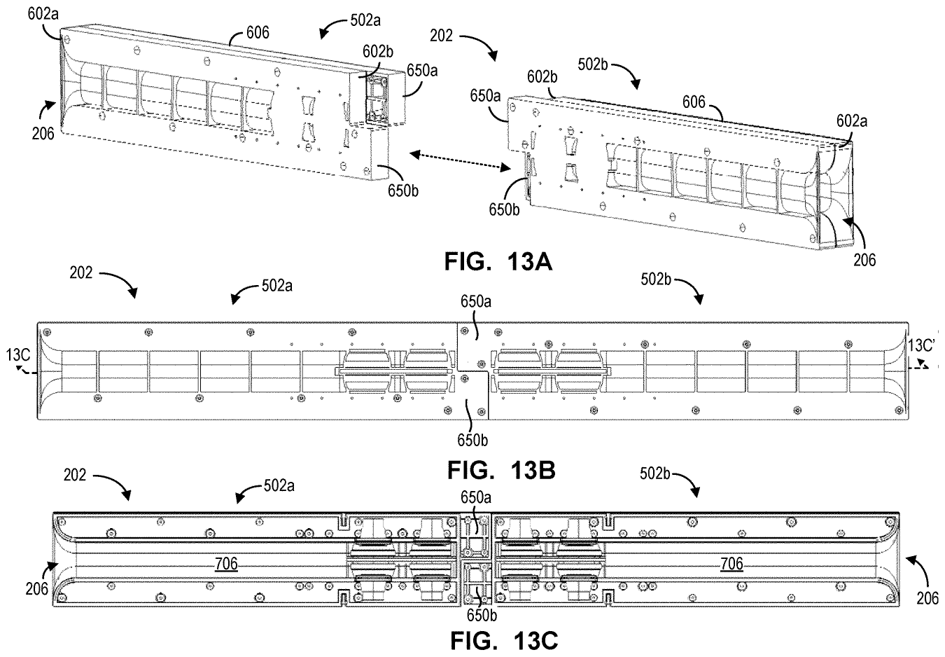

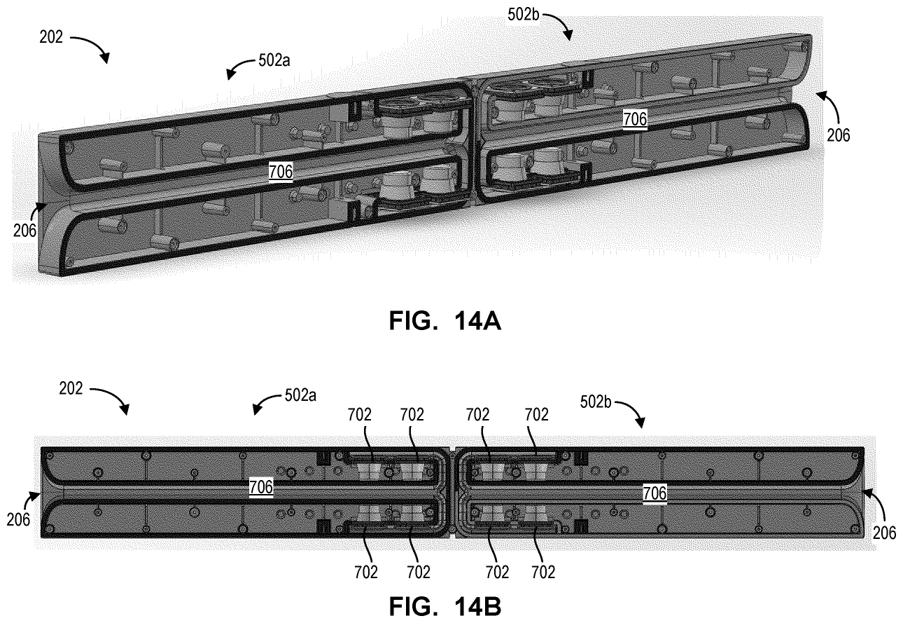

As best shown in FIGS. 13A and 13B, in this configuration, the connectors (650a), (650b) of a first subwoofer module (502a) can mate with the corresponding connectors (650a), (650b) of a second subwoofer module (502b). In turn, this forms the subwoofer assembly (202) comprising two removably coupled subwoofer modules (502) (FIG. 13B), which are in a coupled state (FIGS. 13B and 13C). FIGS. 14A and 14B illustrate a similar concept, but using subwoofer modules (502) in accordance with the embodiment exemplified in FIGS. 10A and 10B.

Other types of coupling mechanisms can be provided to enable coupling of more than two subwoofer modules (502). For example, a coupling mechanism may allow coupling of two, three, four subwoofer modules (502). The connected subwoofer modules (502) may be coupled in any orientation or configuration relative to each other. For instance, four subwoofer modules (502) can be connected in a cross- or plus-sign configuration, such that an outlet opening (206) is located and directed in each of four different directions.

It is also possible to couple together subwoofer modules (502) with different design configurations. For example, any combination of the subwoofer modules (502) exemplified in FIGS. 7-10 can be combined into a subwoofer assembly (202).

In at least one example, the subwoofer modules (502) can be combined as shown in FIG. 15C. This design may allow speaker drivers (702), (1502), in separate modules (502), to cancel the vibration caused by the other driver.

In some examples, the subwoofers modules (502) may not necessarily connect directly to each other. For example, in some embodiments, an elongate spacer can connect between two subwoofer modules (502). For instance, if the subwoofer module (502) is installed behind a wide length television, it may be necessary to further longitudinally space out the opposing output openings (206) (FIG. 13C) to accommodate the wider length television. Accordingly, a spacer can be used between two subwoofer modules (502) to further space out the output openings (206), as desired. In other examples, any other device or module can be interposed between coupled subwoofer modules (502).

### IV. Example Loudspeaker Driver

The following is a description of a loudspeaker driver that may be used by itself or in any combination or sub-combination with any other feature or features described herein. For example, the example loudspeaker driver can be used in conjunction with, or inside, the subwoofer module.

As described herein, the loudspeaker driver is designed with a small form factor (e.g., a small diameter). In this manner, as best shown in FIGS. 15A-15E, the loudspeaker driver (1502) may be incorporated into a shallow depth, elongate subwoofer module (502), as previously described.

In other examples, the disclosed loudspeaker driver (1502) may also be incorporated into other narrow or tight-spaced enclosures, including as internal television speakers, in-wall and/or in-ceiling speakers, as well as into small or narrow structures such as bollards and pendants and the like.

Despite its small size, the loudspeaker driver is adapted to generate loud audio. The loudspeaker driver includes a cap that retracts and extends over long extension ranges to generate the high amplitude audio.

As provided, the loudspeaker driver can be configured as either an active loudspeaker driver or a passive loudspeaker driver.

### (a.) General Description.

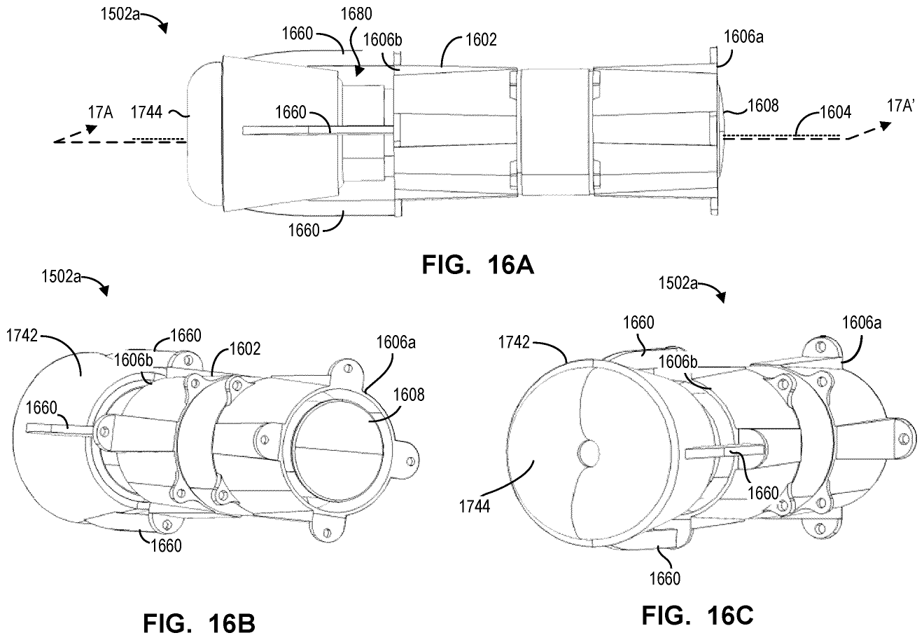

Reference is made to FIGS. 16-18, which exemplify embodiments of a loudspeaker driver (1502), in accordance with embodiments described herein.

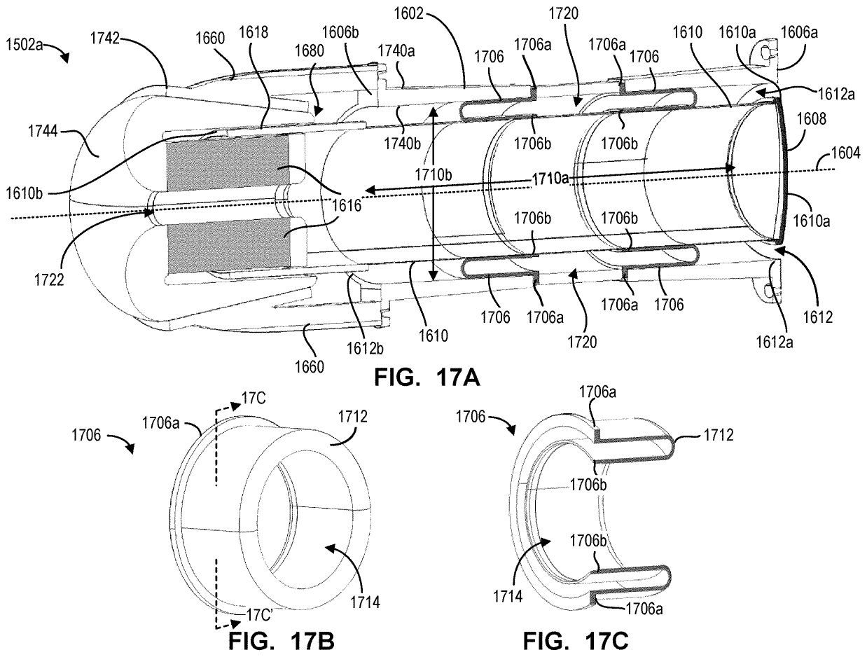

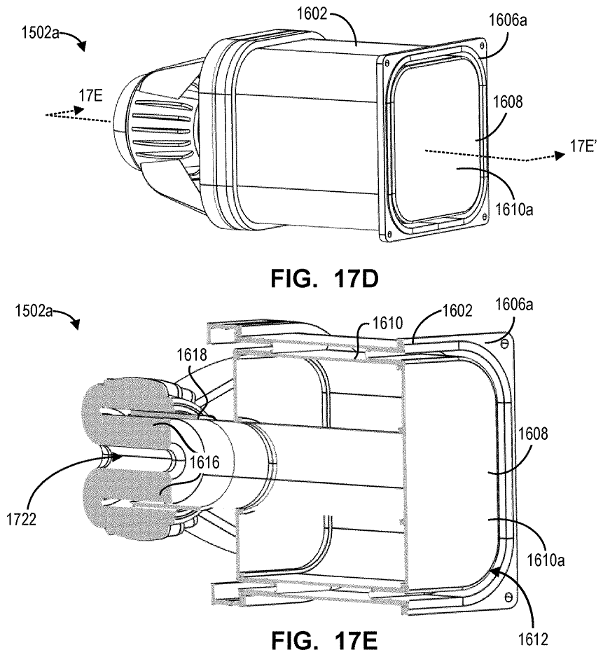

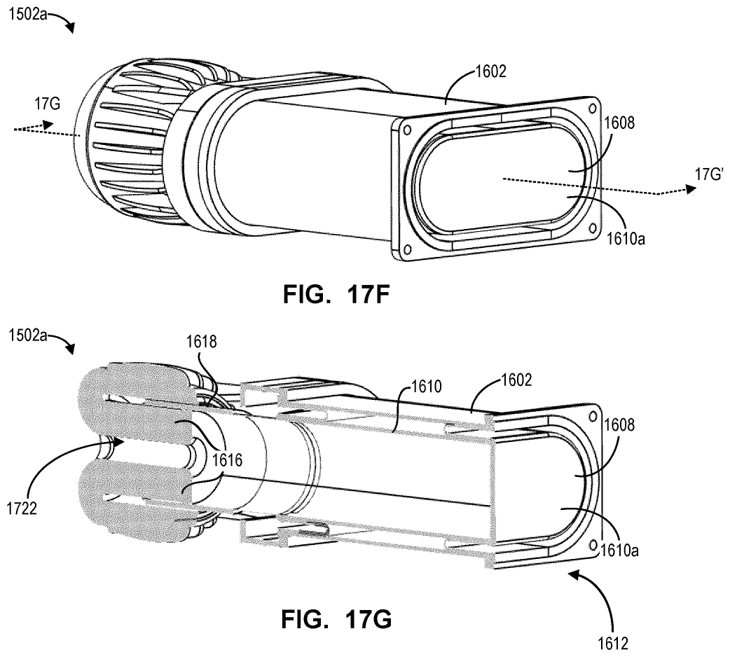

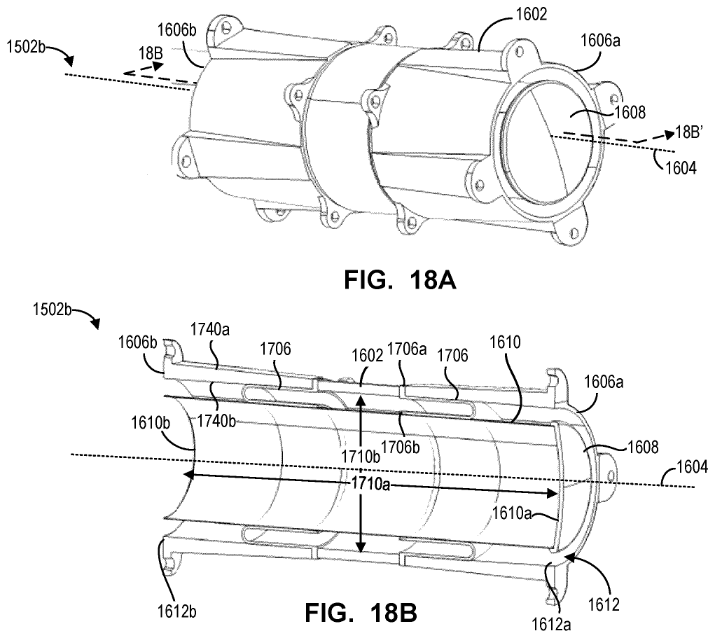

As shown, the loudspeaker driver (1502) can be configured as either: (i) an active loudspeaker driver (1502a) (FIGS. 16-17), or (ii) a passive loudspeaker driver, or passive resistor (1502b) (FIG. 18).

As known in the art, an active driver includes an internal driving mechanism (e.g., a voice coil and magnet assembly). In contrast, a passive driver does not include a driving mechanism, but is driven by external sound pressure waves at resonant frequency. The passive driver resonates at a resonant frequency determined, for example, by its mass and the springiness.

In either case, as best shown in FIGS. 17A and 18B, the loudspeaker driver (1502) generally includes an elongate housing (1602). Elongate housing (1602) extends along an extension axis (1604), between a first open end (1606a) and a second end (1606b) (see e.g., FIG. 18B). The housing (1602) retains various hardware components of the loudspeaker driver (1502).

For ease of description, the first end (1606a) of housing (1602) is referenced herein as the front housing end (1606a). Further, the second end (1606b) is referenced herein as the rear housing end (1606b). It will be understood, however, that that loudspeaker driver (1502) is not limited to any specific orientation, and can be oriented vertically or otherwise at any other angle.

In the case of an active loudspeaker driver (FIG. 17A), housing (1602) may additionally connect to an extended housing portion (1742). For example, extended housing portion (1742) may connect to the rear housing end (1606b). In this case, housing (1602) is referenced as the primary housing (1602), as contrasted to the extended housing (1742).

In this example, the extended housing (1742) connects to the primary housing (1602) via one or more fins (1660) (see also FIGS. 16A-16C). Fins (1660) can act as a heat sink of sorts. Other designs are also possible for the active loudspeaker (1502a). For example, the primary housing (1602) and extended housing (1742) may simply form a single, continuous integrated housing.

As shown in FIG. 17A, extended housing (1742) may house a magnet assembly (1616) for driving the loudspeaker driver (1502a). In some examples, the extended housing (1742) may also house a cup (1744), surrounding the magnet assembly (1616). In some examples, the magnet assembly (1616) and cup (1744) are designed with an axial gap (1722).

As shown, the extended housing (1742) may be absent from the passive loudspeaker driver (1502b) (FIGS. 18A and 18B), as a magnet assembly is not required.

Referring to FIGS. 17A and 18B, “primary” housing (1602) includes an outer surface (1740a) and an inner surface (1740b).

Inner surface (1740b) surrounds an internal elongate chamber (1612). Elongate chamber (1612) extends—along extension axis (1604)—between a first “front” chamber end (1612a) and a second “rear” chamber end (1612b) (see e.g., FIG. 18B). Accordingly, the chamber length (1710a) is defined, along axis (1604a), between the front and rear chamber ends (1612a), (1612b).

In more detail, the front chamber end (1612a) is co-terminus with the open front housing end (1606a). In this manner, the front chamber end (1612a) communicates externally via the open housing end (1606a).

In contrast, rear chamber end (1612b) is located more proximal to the rear housing end (1606b). In some examples, the rear chamber end (1612b) may be co-terminus with the rear housing end (1606b).

Rear chamber end (1612b) may be a closed or open end. In the passive driver (1502b), the rear chamber end (1612b) is open to allow activation of the passive driver at resonant frequency, as known in the art.

As exemplified, elongate chamber (1612) may have a generally cylindrical shape defined by a circular cross-sectional area having a diameter dimension (1710) (FIGS. 17A and 18B). In other examples, however, chamber (1612) may have any other suitable design or shape. For example, chamber (1612) may have a square or rectangular cross-sectional area (FIGS. 17D-17E), or a semi-elliptical cross-sectional area (FIGS. 17F-17G).

While primary housing (1602) is exemplified as a continuous member that surrounds the entire elongate chamber (1612)—it is also possible that the housing (1602) only partially surrounds the chamber (1612). For example, housing (1602) may have gaps and openings along its wall surface. In at least one example, if the loudspeaker driver (1502) is placed within a subwoofer enclosure (or other external environment)—housing (1602) can be integrally formed with that enclosure.

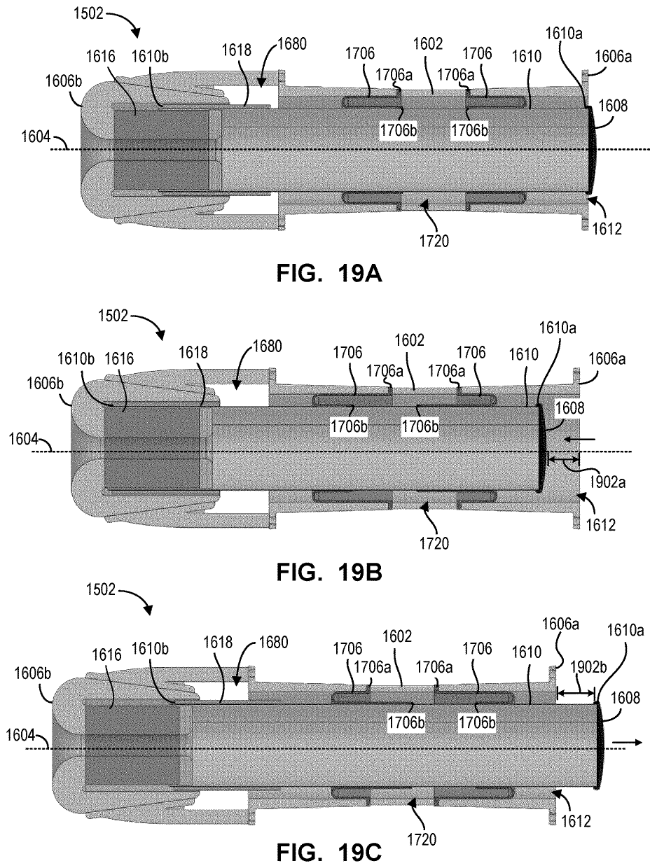

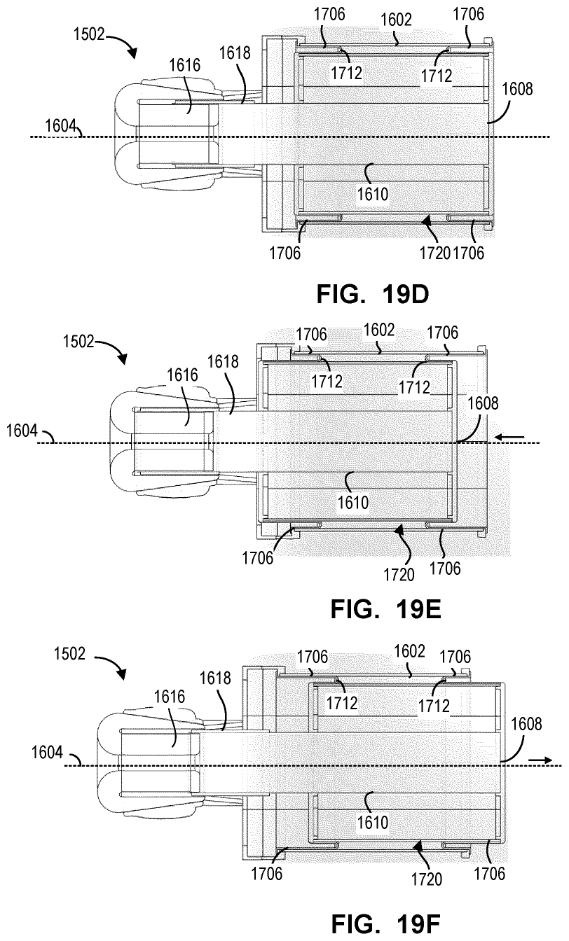

As exemplified in FIGS. 17A and 18B, an elongated translating member (1610) is axially disposed, within chamber (1612). As explained below, translating member (1610) translates relative to housing (1602)—within the chamber (1612)—to generate sound and audio (FIGS. 19A-19C).

To that end, translating member (1610) also extends lengthwise, along axis (1604), between a front member end (1610a) and a rear member end (1610b).

Front member end (1610a) includes a cap (1608). As the translating member (1610) axially translates, cap (1608) generates variable air pressure to generate forwardly travelling sound waves. Rear member end (1610b) may be an open or closed end. In the active drive (1502a) (FIG. 17A), rear member end (1610b) may include (or connect to) a voice coil (1618). As known in the art, voice coil (1618) carries an electric current, and slides over the magnet assembly (1616) to drive axial motion of translating member (1610).

Translating member (1610) may be a solid member, a hollow member, or an at least partially hollow member. The selection of whether the translating member (1610) is solid and/or hollow may depend on various factors, including the desired tuning frequencies of the loudspeaker driver (1502). In the case of a passive driver (1502b) (FIGS. 18A and 18B), this choice can also affect the resonant frequency of the passive driver (1502b).

To this end, cap (1608) on translating member (1610) may have any suitable shape or design, e.g., which can complement the design of the chamber (1612). For example, cap (1608) can have a circular shape (FIG. 17A), a rounded rectangular shape (FIGS. 17D-17E), or a semi-elliptical shape (FIGS. 17F-17G).

In some examples, the cross-sectional area of cap (1608) is varied (e.g., increased or decreased) to push more or less air during operation of the speaker driver (1502a). This, in turn, can increase the potential maximum volume of the speaker. For example, the cap (1608) of FIGS. 17D-17G has a larger cross-sectional area than the cap (1608) of FIG. 17A, and therefore can a push larger volume of air. Accordingly, the exemplified designs in FIGS. 17D-17G can be used in applications requiring, for example, louder output sound.

### (b.) Translation Positions for Translating Member.

FIGS. 19A-19C exemplify different translation positions for the translating member (1610). While FIGS. 19A-19C exemplify the translation positions for an active driver (FIG. 17A), the same principles apply for a passive driver (FIG. 18B).

As shown, in operation, translating member (1610) translates axially between an initial “rest” position (FIG. 19A) and one of a retracted position (FIG. 19B) and an extended position (FIG. 19C).

In the active driver (1502a), the translation between the different positions occurs owing to the driving mechanism (e.g., voice coil and magnet assembly). In the passive driver (1502b), the different translation positions result from external sound pressure, at the resonant frequency, acting on the second end (1610b) of translating member, as known in the art.

As noted, as the translating member (1610) moves between the extended and retracted positions (FIGS. 19B and 19C)—the cap (1608) generates variable sound pressure waves, which generates audio.

In more detail, in the retracted position (FIG. 19B), the translating member (1610) translates in a first direction, along extension axis (1604) (e.g., a rearward direction). This causes the cap (1608) to retract by a maximum retraction distance (1902a).

In contrast, in the extended position (FIG. 19C), translating member (1610) translates in an opposite second direction, along extension axis (1604) (e.g., a forward direction). This causes the cap (1608) to move to a maximum extension distance (1902b). Maximum extension distance (1902b) may the same or different than the maximum retraction distance (1902a).

An appreciated advantage of the exemplified design is that the loudspeaker driver (1502) can generate loud audio due to the large travelling distance of the cap (1608). In other words, with larger maximum extension and retraction distances (1902a), (1902b), the cap (1608) is able to generate larger sound pressure waves.

In this manner, despite the small or narrow cross-sectional area of housing (1610) (e.g., small diameter (1710b))—loudspeaker driver (1502) can still generate louder and higher-amplitude audio than existing small form factor loudspeaker drivers, and with better sound pressure levels (SPLs). As such, the loudspeaker driver (1502) can be mounted in narrow shallow depth subwoofer modules (FIGS. 15A-15C), and still generate loud audio.

In at least one example, with a two (2) inch diameter (1710), the driver (1502) may be adapted with a maximum and minimum extension distance (1902a), (1902b) of 50 mm.

It will be appreciated that the maximum travelling range of the cap (1608)—i.e., defined between (1902b) and (1902a)—is at least partially a function of the length of the translating member (1610).

### (c.) Support Members.

As best shown in FIGS. 17A and 18B, loudspeaker driver (1502) can also include one or more support members (1712).

Support members (1712) generally function to maintain the position of translating member (1610) within the housing (1602), as the translating member (1610) is moving. In other words, the support members (1712) provide a centering force in a direction orthogonal to the translating axis (1604).

For example, in a cylindrical housing (1602)—support members (1712) concentrically align the translating member (1610), within housing (1602). This prevents displacement of the translating member (1610) during axial movement (FIGS. 19A-19C). In this manner, the support members (1712) functional analogous to a spider in a normal loudspeaker driver.

Any suitable support member (1712) known in the art can be used. In at least one example, the support member (1712) is a flexible support member, such as a flexible rolling support member (1712).

With concurrent reference to FIGS. 17B and 17C, the rolling support member (1706) can comprise a flexible rolling band. The flexible band rolls and unrolls with axial movement of translating member (1610). In at least one example, the flexible band is formed of a layer of rubber and/or a layer of fabric.

As exemplified in FIGS. 17B and 17C, the rolling support member (1706) includes a first member end (1706a) and a second member end (1706b). First member end (1706a) is secured within the driver housing (1602), e.g., the inner housing surface (1740b). Second member end (1706b) is secured to the translating member (1610). In this manner, the rolling support member (1706) extends inside the elongate chamber (1612), and between the housing (1602) and translating member (1610).

In the exemplified embodiments, rolling support member (1706) has an annular design that complements the cylindrical shape of translating member (1610). The annular member (1706) surrounds the entire outer perimeter (e.g., circumference) of the translating member (1610).

In this configuration, translating member (1610) is therefore received within a circular opening (1714) of the annular support member (1706). An advantage of this design is more complete surround support, and positional alignment, around the entire outer perimeter of translating member (1602).

In other examples, it is not necessary that the rolling member (1706) surround the entire outer perimeter of translating member (1610). Further, rather than being annular, the rolling member (1706) may have any other shape or design that, for example, complements the shape and design of the translating member (1610). For example, in FIGS. 17D-17G, the support member (1706) can have a rounded rectangular design (FIGS. 17D-17E) or a semi-elliptical design (FIGS. 17F-17G).

As exemplified, rolling member (1706) bends over itself, to form a U-shape (1712). As such, while translating member (1610) is moving—rolling member (1706) rolls and unrolls such that the first end (1706a) translates relative to the second end (1706b) (see e.g., FIGS. 19B and 19C).

At least one appreciated advantage of this design is to facilitate a greater range of axial motion of translating member (1610). For example, as translating member (1610) extends in either the forward and rearward directions, translating member (1610) is continuously supported by the extended rolling and unrolling of rolling member (1706), in both directions. This enables designing the translating member (1610) to extend and retract farther distance to generate louder audio. In contrast, other designs for support member may not necessarily accommodate a similar range of wide axial motion.

More generally, the use of the flexible rolling member (1706) provides a “soft stop” for the translating member (1610) when it reaches either the maximum retracted or extended positions (FIGS. 19B and 19C). This provides for more efficient operation of the loudspeaker driver (1502). This is contrasted to designs where the support member increases in linear stiffness versus axial displacement, which causes undue resistance and wasted energy.

In other examples, support member (1706) can comprise any other flexible or movable structure, device or assembly. Further, the support members (1706) can be provided at any location along the axial length of the translating member (1610).

To that end, loudspeaker driver (1502) can include any number of support members (1706). If more than one support member (1706) is provided, the support members can be of similar or different design.

In the illustrated example, two rolling support members (1706) are provided, and spaced along axis (1604). In this example, the two rolling members (1706) are inversely oriented. For example, the U-bend portion (1712), of each member, is oppositely directed, e.g., along axis (1604). In other examples, the U-bend portions (1712) may be directed to face each other (e.g., FIGS. 19D-19F). As best shown in FIGS. 19B and 19C (as well as FIGS. 19D-19F), this inverted configuration results in one flexible member (1706) rolling while the other member is un-rolling.

An appreciated advantage of using two inverted rolling support members (1706), as exemplified, is that a sealed area of constant air volume (1720) is formed in-between the rolling members (1706) (FIG. 17A).

For example, as shown in FIGS. 19A-19C, irrespective of which rolling member (1706) is rolling or un-rolling at a given instance—the volume area (1720) in-between is maintained constant. This is due to inverse and symmetric rolling/unrolling of each rolling member (1706).

In at least some cases, the constant area volume (1720) maintains the structural stability of the support members (1706), and otherwise, prevents the support members from collapsing under changing air pressure.

For instance, when the loudspeaker driver (1502) is deployed in a subwoofer module (502) (FIG. 15B)—a changing pressure differential is generated as the translating member (1610) translates in either direction. This is because, as the translating member (1610) translates rearward, it pushes air into the cabinet (714). Further, when translating forwardly, it sucks air from the cabinet (714). This change in pressure can cause the support members (1706) to collapse, or otherwise structurally distort. However, the constant air volume (1720) acts as a counteracting force, to maintain the structural stability of each rolling support member (1706). The same concept can also apply to another design for a flexible or moving support member (1706).

In examples where loudspeaker driver (1502) includes more than one rolling support member (1706)—the multiple rolling members can be installed in inverse sets of pairs, as shown. In this manner, a constant air volume (1720) is provided between each pair set.

### (d.) Heatsink.

As indicated previously, the active loudspeaker driver (1502a) (FIGS. 16-17) can include a heatsink portion (1660) comprising multiple longitudinal fins (1660).

As shown in FIGS. 16A and 17A, a gap (1680) may be formed between the primary and extended housings (1602), (1740). Gap (1680) may allow an air current to pass in-and-out of the driver (1502a) as the translating member (1660) extends and retracts (FIGS. 19A-19C). This air current may pass through the fins (1660) and allow heat exchange between the air current and the heat sink fins (1660).

### (e.) Restoring Force.

In examples where the loudspeaker driver (1502) is deployed in a sealed volume (e.g., a sealed cabinet (714) in a subwoofer module)—a natural restoring force may be generated for translating member (1610). This natural restoring force is generated by varying air pressure levels in the sealed volume.

For example, in FIGS. 15B and 15C, the active loudspeaker driver (1502a) is fully received within the sealed cabinet (714). In this configuration, only the front open housing end (1606a) is exposed outside of the sealed cabinet (714) (e.g., to direct audio to a port (706) or an outside environment).

In this example, as discussed—as the translating member (1610) extends and retracts—airflow is exchanged through the gap opening (1680), formed between the primary and extended housing portions (1602), (1742) (FIGS. 16A, 17A). In turn, this causes a pressure differential in the sealed cabinet (714), or otherwise, in a sealed volume housing the loudspeaker driver (1502a).

When the translating member (1610) extends, it absorbs air from the sealed cabinet (714), causing negative pressure build-up inside the sealed cabinet (714). This negative pressure acts as a restoring force to retract back the translating member (1610).

In the inverse, when the translating member (1610) retracts, it pushes air into the sealed cabinet (714), causing positive pressure build-up inside the cabinet (714). This positive pressure also acts as a restoring force to push the translating member (1610) back to an extended position.

Accordingly, despite the support member (1760) have no intrinsic self rebound force, the varying air pressure inside the sealed volume can act as an external rebound force.

A similar principle applies to the passive loudspeaker driver (1502b) (FIG. 18). In this case, however, airflow may be exchanged with the sealed cabinet (714) via the open rear housing end (1606b) (FIG. 18B).

(f.) Combinations of Active and/or Passive Loudspeaker Drivers.

As exemplified in FIGS. 15D-15E, the active and passive loudspeaker drivers (1502a), (1502b) can be combined in a single sealed enclosure. For example, the loudspeaker drivers (1502) can be combined in a single subwoofer module (1550d), sharing a common sealed cabinet (714). In this design, the active driver (1502a) can drive the passive driver (1502b) at the correct resonant frequency the passive driver (1502b) is tuned for.

In FIG. 15D, the passive driver (1502b) feeds into port (706), while the active driver (1502a) faces directly externally. In other examples, the active driver (1502a) may also feed into the same or a different port (706). Further, each of the active and passive drivers (1502) can be oriented in any orientation or position within the enclosure (1550d).

In some examples, the active driver (1502a) is used by itself, or paired with other passive drivers or radiators, e.g., conventional passive radiators. Similarly, the passive driver (1502b) can be paired with other active drivers, e.g., conventional active loudspeaker drivers.

As exemplified in FIG. 15E, the subwoofer module (1502d) can be combined to form a subwoofer assembly (202).

In some examples, the subwoofer assembly (202) can include a mix and match of subwoofer modules (1502), with other subwoofer modules (502), previously described. The other subwoofer modules (502) may or may not incorporate the loudspeaker drivers (1502).

### V. Example Loudspeaker Assembly

The following is a description of a loudspeaker assembly (204) that may be used by itself or in any combination or sub-combination with any other feature or features described herein. For example, the example loudspeaker assembly (204) can be used in conjunction with the subwoofer assembly (202).

### (V.i) General Description

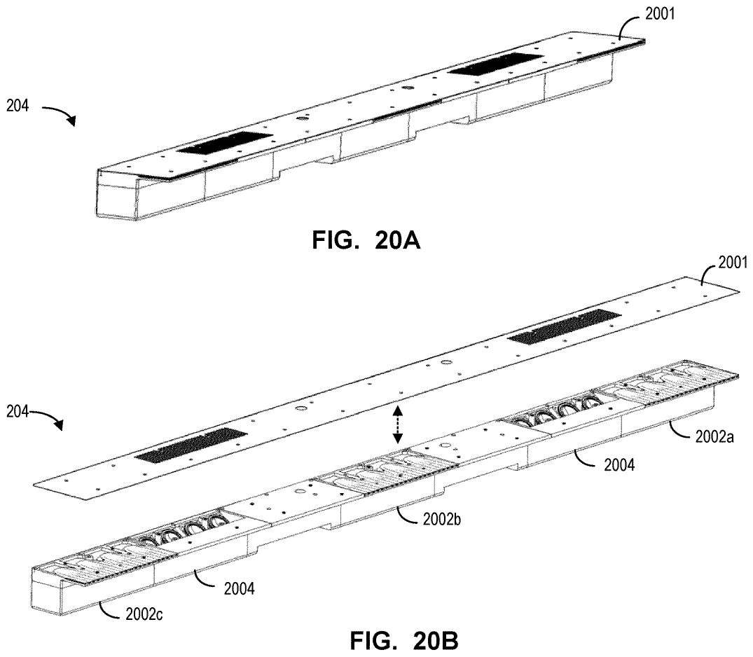

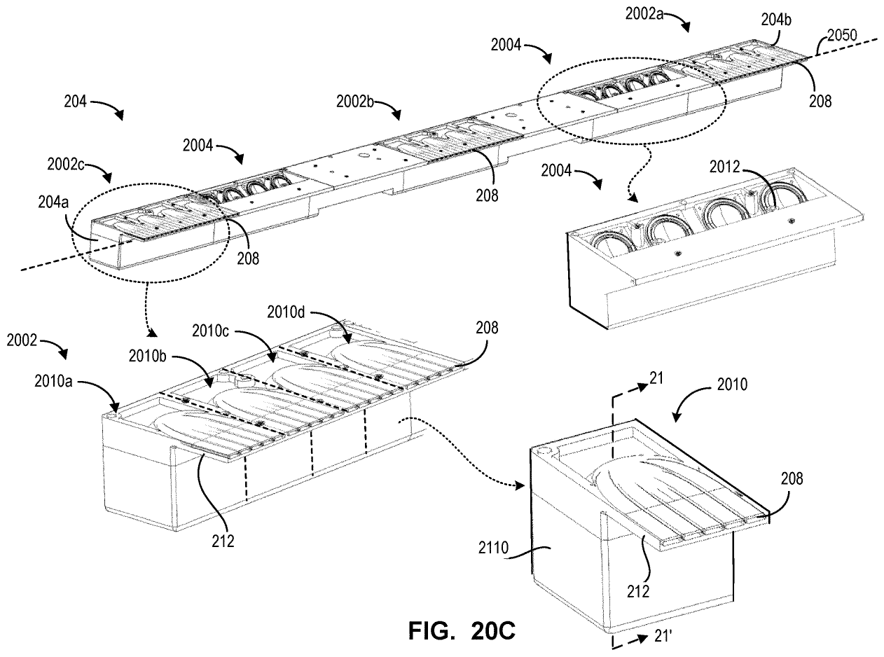

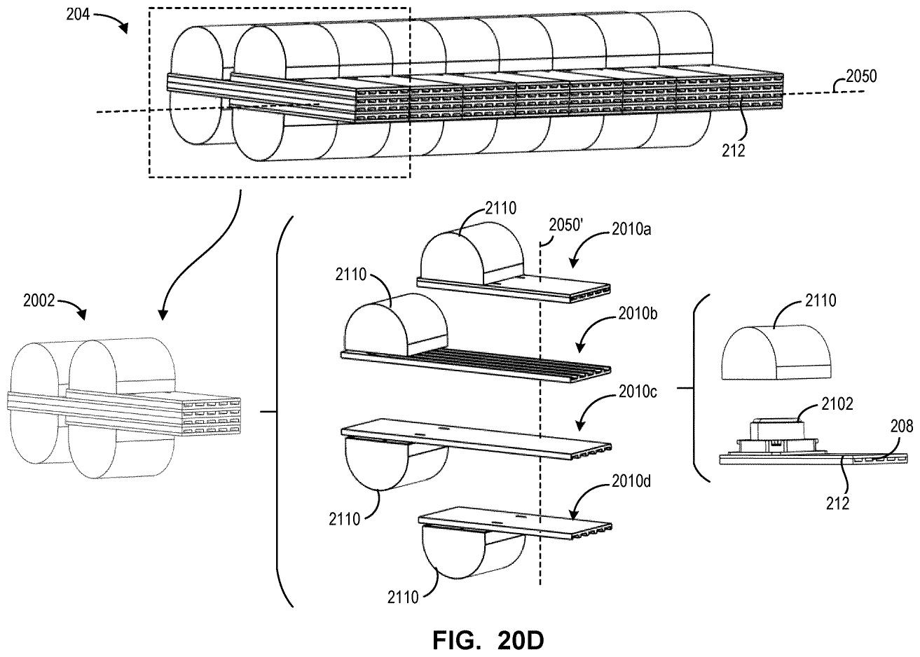

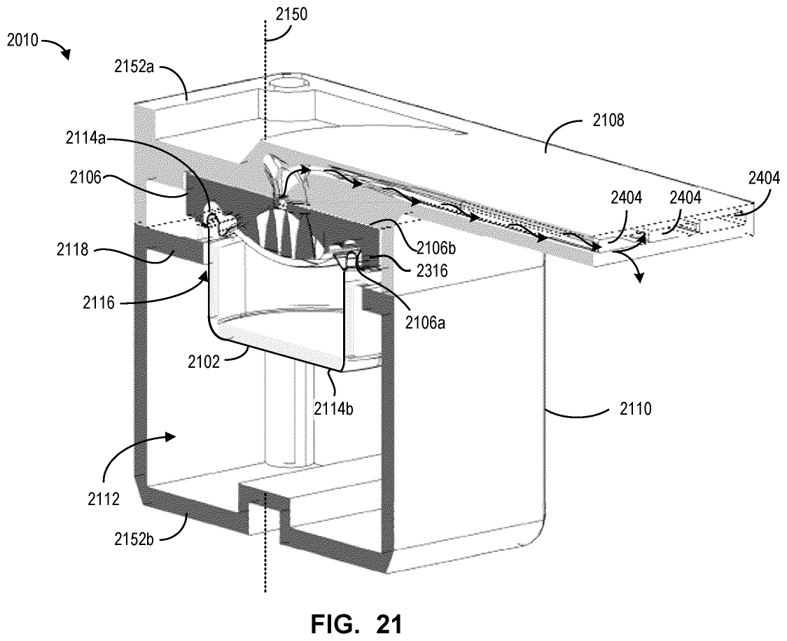

Reference is now made to FIGS. 20A-20C, which illustrate an example loudspeaker assembly (204).

As shown, loudspeaker assembly (204) can include a combination of one or more loudspeaker systems (2002) (FIG. 20C). The loudspeaker systems (2002) can be removably coupled (e.g., modular systems), or otherwise, permanently coupled (e.g., integrally molded). For instance, loudspeaker systems (2002) can be coupled along a longitudinal axis (2050) (FIG. 20C). Loudspeaker systems (2002) can also couple in any other designed configuration.

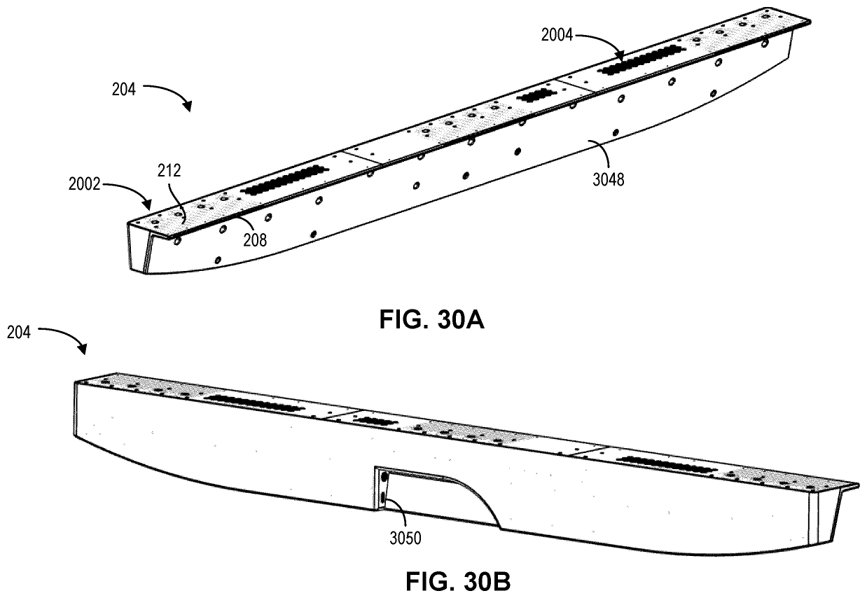

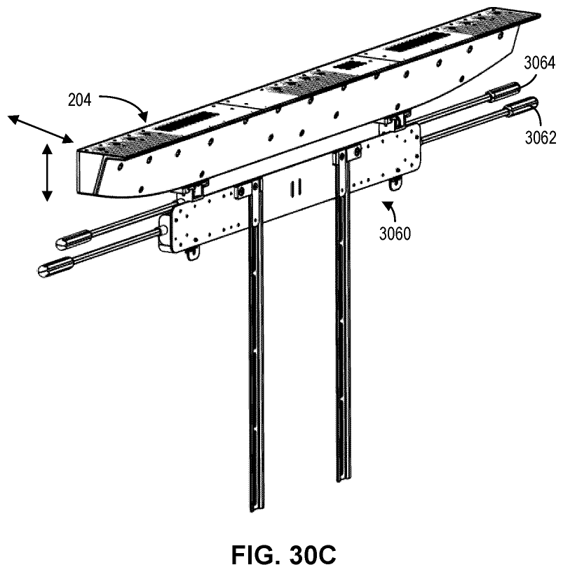

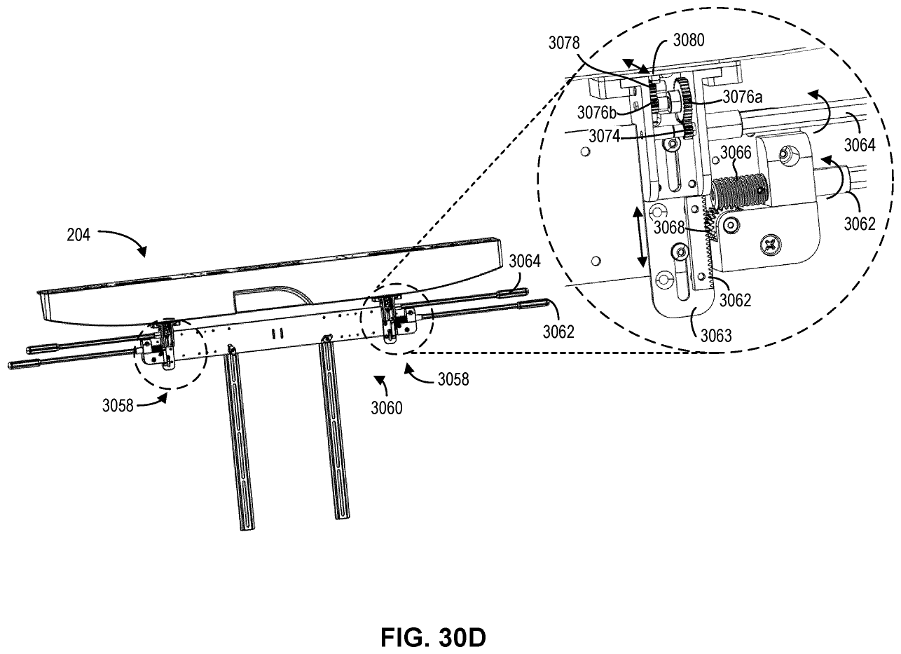

In some examples, the loudspeaker assembly (204) can be retained in a housing (3048) (FIGS. 30A-30B), which retains the various electronics. Housing (3048) can include, for example, connecting ports (3050).

As best shown in FIG. 20C, loudspeaker systems (1502) can include one or more: (i) “micro-aperture” loudspeaker systems (2002), and (ii) “up-firing speaker systems” (2004). In one example, only the micro-aperture systems (2002) are provided.

### (a.) Micro-Aperture Loudspeaker Systems (2002).

In at least one example, the “micro-aperture” systems (2002) are used to direct audio towards a listener (e.g., audio (108a) in FIG. 1B). As exemplified in FIGS. 2B-2D, a unique feature of the micro-aperture systems (2002) is that they include a series of small (or “micro”) audio output apertures.

The micro-apertures can extend in an overhang portion (212) of the loudspeaker assembly (204). Accordingly, assembly (204) may be placed behind an object (e.g., television (106)) with the overhang portion (212) resting over the object. In this position, micro-apertures (208) are positioned to direct audio to a listener, but are barely visible, owing to their small size. In this manner, the apertures do not detract from the overall aesthetic of the surrounding environment. Further, despite their small size, the micro-apertures (208) can generate room-filling sound.

In the exemplified embodiments, the loudspeaker assembly (204) includes, all together, three micro-aperture systems (2002a)—(2002c). Systems (2002a)-(2002c) are spaced out longitudinally, along the axial length of assembly (204). For example systems (2002a)-(2002c) are disposed centrally, as well as at the first and second ends (204a), (204b) of assembly (204). In an up-right horizontal position, this arrangement directs audio to left, right and centrally. In other examples, any other positional arrangement and/or configuration of micro-aperture systems (2002a) are used.

In the exemplified embodiment of FIG. 20C, each micro-aperture system (2002a) includes one or more micro-aperture loudspeaker modules (2010). Modules (2010) are also either removably or permanently coupled. In the illustrated example, each micro-aperture system (2002) includes four modules (2010a)-(2010d). In other examples, each system (2002) has a different number of micro-aperture modules (2010).

The modules (2010), comprising the micro-aperture system (2002), may also be arranged in any configuration. For example, in FIG. 20C, the modules (2010) are arranged side-by-side, such that their overhang portions (212) and housing cabinets (2110) are aligned along the common axis (2050).

FIG. 20D exemplifies another configuration where the modules (2010), in each system (2002), are stacked over each other, and along a stacking axis (2050′). Stacking axis (2050′) may be orthogonal to the longitudinal axis (2050). This design results in the overhang portions (212) also being stacked over each other. In this example, there are four stacked modules (2010). The modules (2010) can be stacked in any manner. In this example, the two lower modules (2010c), (2010d) are inverted relative to the two upper modules (2010a), (2010b). Further, the middle modules (2010b), (2010c) extend further rearwardly relative to the outer modules (2010c), (2010d). As exemplified, this design ensures that the cabinet housings (2110)—housing the loudspeaker drivers (2102)—do not interfere with each other. More generally, an appreciated advantage of this design is to allow the loudspeaker assembly (204) to scale and accommodate a larger number of micro-aperture modules (2010) (e.g., to generate louder outputs sounds, such as in outdoor environments).

In at least one example, in the design of FIG. 20D, the output openings (208) from each of the four modules (2010), may be combined into a single output opening (208). That is, a single set of output openings (208) is shared (e.g., common) between the four modules (2010). This may allow increasing the sound pressure level (SPL) capability of the system and/or allowing for different industrial design configurations.

To that end, it will be understood that it is possible for the entire loudspeaker assembly (204) to comprise just a single micro-aperture system (2002). For example, assembly (204) can include a single micro-aperture system (2002) which, itself, comprises a large number of micro-aperture modules (2010). In that example, micro-aperture modules (2010) are coupled together to extend from the first end to the second end (204a), (204b) of the loudspeaker assembly (204). The skilled artisan will appreciate the possibility of various alternatives for configuring the assembly (204) and each micro-aperture system (2002).

### (b.) Up-Firing Speaker System (2004).

Optionally, assembly (204) also includes up-firing speaker systems (2004) (otherwise known as ceiling reflecting speaker systems).

In an upright position, these speakers generate, and direct audio upwardly to reflect of a ceiling (see e.g., (108b) in FIG. 1B). This can allow the loudspeaker assembly (204) to generate more room-filling audio.

As shown in FIG. 20C, the up-firing speaker system (2004) can include one or more loudspeaker drivers (2012). In the upright position, the drivers (2012) are directed upwardly, or upwardly at an angle (e.g., an angle to an axis orthogonal to the longitudinal axis (2050)). In some examples, each driver (2012) is oriented differently to allow directing audio in different directions.

In the exemplified, the loudspeaker assembly (204) includes two up-firing speaker systems (2004) (FIG. 20C). For instance, the up-firing speaker systems (2004) are spaced axially along the length of the assembly (204).

In other examples, any number of up-firing speaker systems (2004) can be provided. Each up-firing speaker system (2004) can include the same or a different number of drivers (2012).

As best shown in FIG. 20A, loudspeaker assembly (204) may also include a top cover (2001). Top cover (2001) can include one or more perforated section (e.g., grills) aligned over the up-firing speaker section (2004).

### (V.ii) Example Micro-Aperture Loudspeaker Module (2010)

Reference is now made to FIGS. 21-26, which show an example “micro-aperture” loudspeaker module (2010). The described module (2010) can be used by itself, or in combination with other components or sub-components described herein.

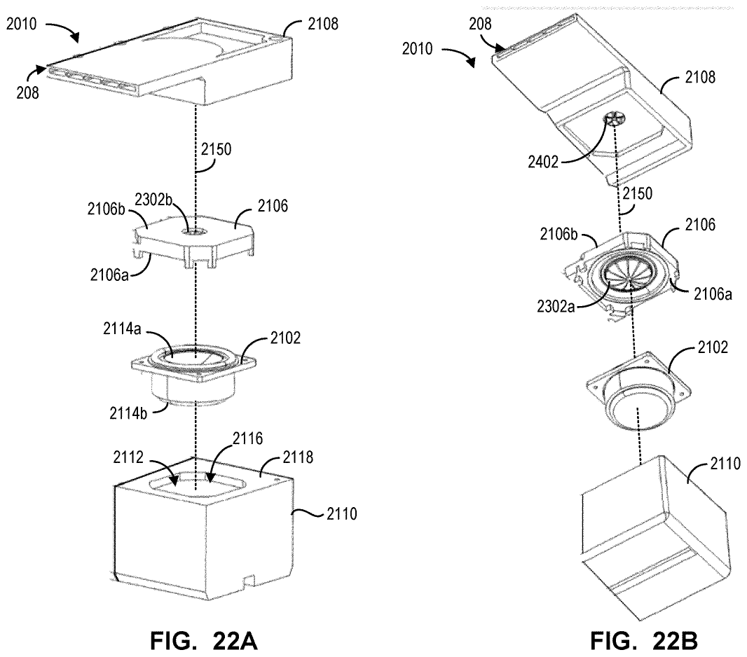

As best shown in FIGS. 22A-22B, the loudspeaker module (2010) provides a housing enclosure for a loudspeaker driver (2102). Speaker driver (2102) may include a front end (2114a), and an opposite rear end (2114b). As defined herein, the front end (2114a) is configured to emit audio or sound waves. In at least one example, speaker driver (2102) is a midrange tweeter. In some examples, speaker driver (2102) may be removable and/or replaceable within the loudspeaker module (2010).

As exemplified, loudspeaker module (2010) generally includes a phase guide member (2106), an acoustic waveguide member (2108) and a cabinet member (2110). In some examples, the module (2010) may not necessarily include the cabinet member (2110).

As shown in FIG. 21, in an assembled state, speaker driver (2102) is at least partially received within the cabinet member (2110). For example, the driver's second, rear end (2114a) is receivable inside the cabinet (2110), i.e., within hollow volume (2112). In contrast, the driver's first, front end (2114a) is disposed outside of the cabinet (2110). Cabinet (2110) can therefore function as an acoustic suspension enclosure.

Cabinet (2110) may include an opening (2116) adapted (e.g., sized or dimensioned) to receive the speaker driver (2102). In an upright position, opening (2116) may be formed within a top surface (2118) of the cabinet member (2110). The remaining surfaces of the cabinet member (2110) may be closed.

In this configuration, the speaker driver (2102) can rest over the cabinet member (2110), with the front driver end (2114a) facing away. In other examples, cabinet opening (2116) can be formed along any other surface of the cabinet member (2110).

As shown in FIGS. 22A-22B, phase plug member (2106) interfaces with the speaker driver (2102). In more detail, the phase plug member (2106) engages and covers over the first driver end (2114a). Accordingly, any audio emitted by the speaker driver (2102) is directed into the phase guide member (2106). The waveguide member (2108) then further interfaces over the phase guide member (2106) to further direct the audio (see e.g., example arrows in FIG. 21).

In at least one example, the stacking (or interfacing) occurs along a longitudinal axis (2150) (FIGS. 22A and 22B). In this manner, the loudspeaker module (2010) extends along the axis (2150), between a first end (2152a) and a second end (2152b) (FIG. 21). First end (2152a) comprises the waveguide member (2108), while second end (2152b) comprises a surface of the cabinet (2110). If the cabinet (2110) is not included, then the second end (2152b) correspond to the driver rear end (2114b).

It is not necessary, however, for the module (2010) to extend along a linear longitudinal axis (2150). For example, it is possible for module (2010) to curve or bend along its length. For instance, in some examples, the waveguide member (2108) is oriented at an angle relative to the phase plug member (2106) and/or speaker driver (2102), insofar as all the components interface with each other as exemplified.

An example design and configuration for the phase plug (2106) and waveguide (2108) members is now described herein.

### (a.) Example Phase Plug Member (2106).

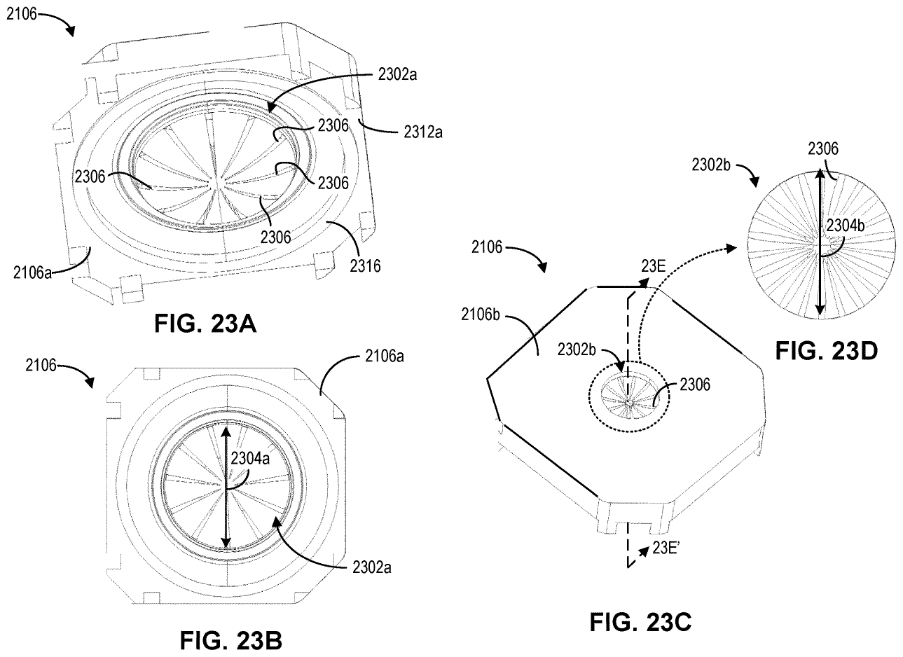

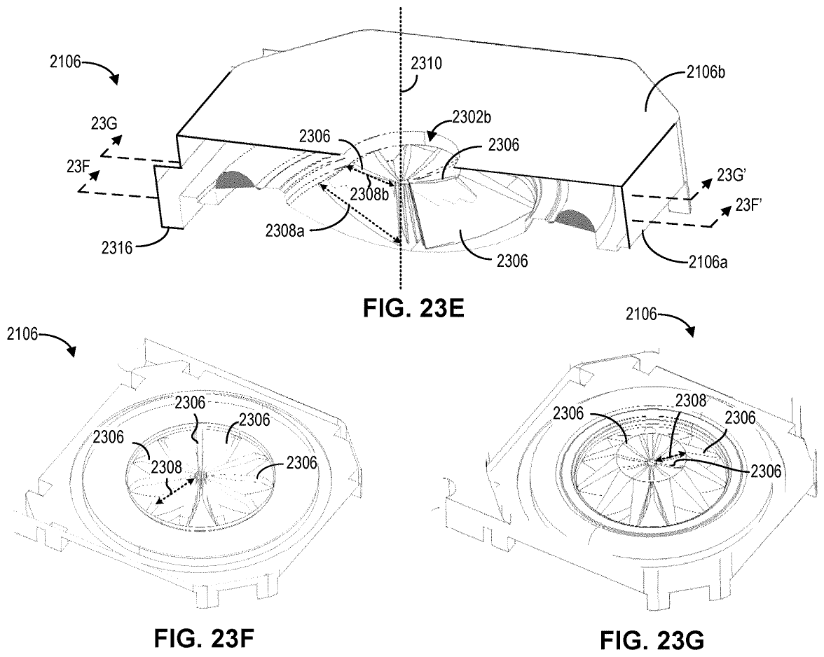

Reference is now made to FIGS. 23A-23D which exemplify an embodiment of the phase plug member (2106).

As exemplified, phase plug member (2106) includes a first side (2106a) and an opposed second side (2106b). First side (2106a) includes an audio inlet portion (2302a) (FIGS. 23A and 23B). Second side (2106b) includes an audio outlet portion (2302b) (FIGS. 23C and 23D). Audio outlet portion (2302b) communicates with the audio inlet portion (2302a) via one or more openings, passing within the phase plug (2106).

In-use, audio is generated from the speaker driver (2102), and enters the phase plug (2106) through the audio inlet portion (2302a). Audio inlet (2302a) may cover over the first driver end (2114a) to receive generated audio. Audio then travels through the phase plug (2106), and exits from the audio outlet portion (2302b).

In this example, phase plug (2106) is plate-like member extending along a linear axis (2310) (FIG. 23E). Further, the audio inlet (2302a) and audio outlet (2302b) are located on opposite sides of the plug member (2106).

In other examples, however, phase plug (2106) can have any other design. For instance, it is not necessary that the phase plug (2106) is a plate-like member. For example, phase plug (2106) can curve and bend such that the first side and second sides (2106a), (2106b) are not necessarily 180° apart.

In some embodiments, it is also possible for the audio inlet portion (2302a) and audio outlet portion (2302b) to be located on the same side of the phase plug member (2106). In these cases, an opening or passage can still pass through the phase plug member between the audio inlet and outlet portions. Audio inlet and output portions can also exist on any other side or face of the phase plug member (2106).

As explained, as audio travels through the phase plug (1606)—between the inlet and outlet portions (2302a), (2302b)—phase plug (2106) functions to compress the sound energy to transform the audio into a compressed energy state.

Compression of audio sound energy can occur in various manners. In the exemplified embodiments, the compression occurs by designing the audio outlet (2302b) to have a smaller cross-sectional area, than the audio inlet (2302a). Accordingly, sound energy—travelling through the phase plug (2106)—is pressurized and compressed as it travels from the larger audio inlet (2302a) and exits the smaller audio outlet (2302b).

In the illustrated embodiments, each of the audio inlet and outlet (2302a), (2302b) is circularly shaped. The circular shape—of audio inlet (2302a)—complements the circular design of the first driver end (2114a) (FIG. 21). Accordingly, the audio inlet (2302a) can overlap, or interface over the first driver end (2114a), such that all sound generated by the speaker driver (2102) is received inside the phase plug (2106).

Additionally, the audio inlet (2302a) is shown as having a convex shape, to also complement the concave shape of the first driver end (2114a).

In other examples, the audio inlet (2302a) inlet can have any other suitable shape, design and/or configuration, e.g., to complement the size and of the loudspeaker driver (2102). This includes designing the audio inlet (2302a) with a concave or flat design. Similarly, the audio outlet (2302b) can have any suitable design, which is the same or different from the audio inlet (2302a).

In the exemplified configuration, the audio inlet portion (2302a) has a diameter (2304a) (FIG. 23B) larger than the diameter (2304b) of the audio outlet portion (FIG. 23D). This reduction in diameter causes the aforesaid compression of sound energy travelling through the phase plug (2106). In at least one example, the diameter (2304a) is 1 inch, while the diameter (2304b) is only 1 centimeter.

As shown in FIGS. 23E-23F, one or more vent openings (2306) (e.g., a plurality of vent openings) connect the audio inlet (2302a) to the audio outlet (2302b). Vent openings (2306) extend between the audio inlet portion (2302a) and the audio outlet portion (2302b).

In the exemplified embodiment, vent openings (2306) comprise slot-like openings. Vent opening (2306) may extend radially outwardly, within the phase plug (2106).

The vent openings (2306) reduce in length and cross-sectional area as they extend between the audio inlet (2302a) and audio outlet (2302b). This reduction in dimensions forces compression of sound energy, as it travels through phase plug (2106).

For example, at the audio inlet (2302a), the vent openings (2306) have a first radial length (2308a) (FIG. 23E). First radial length (2308a) may be substantially equal to the radius of the audio inlet (2302a) (FIG. 23B).

At the audio outlet portion (2302b), the vent openings (2306b) have a reduced, second radial length (2308b). Second length (2308a) is substantially equal to the radius of the audio outlet portion (2302a) (FIG. 23E). The second length (2308b) is less than the first length (1808a).

As shown in FIGS. 23F and 23G, the vent opening length (2308) gradually decreases between the audio inlet (2302a) and the audio outlet (2302b). Further, the lateral width of each vent opening (2306) also decreases. In turn, the cross-sectional area of each vent opening decreases axially, to enable compression of the audio energy.

It will be understood that FIGS. 23A-23G exemplify only one design configuration for vent openings (2306). Other configurations are also possible, while having the same result of compressing sound energy.

For instance, vent openings (2306) are not necessarily slots which extend radially. For example, vent openings (2306) can comprise frustoconical shaped openings. As known in the art, the narrowing diameter of a frustoconical design can also function to compress sound energy. In at least one example, a single frusto-conical opening (2306) connects the audio inlet (2302a) to the audio outlet (2302b).

Optionally, the phase plug member (2106) can include a position aligning portion (2316) (FIGS. 21, 23A, 23E). For example, the aligning portion (2316) can include an extended lip, on the first plug side (2106a), which is used to align the speaker driver (2102) relative to the plug member (2106), e.g., preventing positional misalignment due to vibration.

While the plug member (2106) is described as being a single molded component, it is possible that the plug member (2106) may also, in-fact, comprise a plurality of components which, together, provide the described function of phase plug member (2106).

### (b.) Example Waveguide Member (2108).

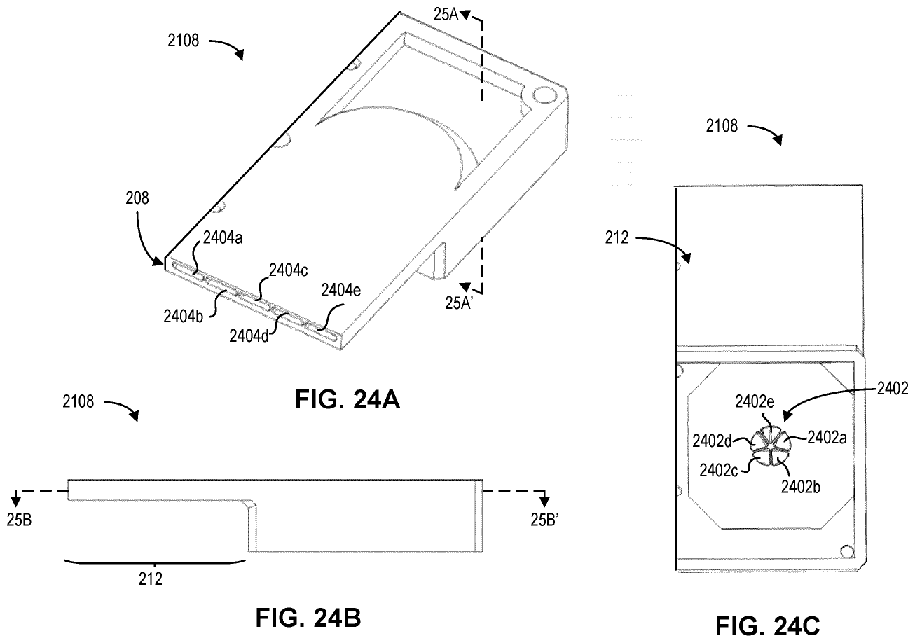

Reference is now made to FIGS. 24-26, which exemplify embodiments of the waveguide member (2108).

As shown in FIGS. 24A-24C, the waveguide member (2108) also include an audio inlet portion or area (2402) and an audio outlet portion (208). Each of the audio inlet and outlet includes one or more openings. For example, the audio inlet portion (2402) includes one or more inlet openings (2402a)-(2402e) (FIG. 24C). Similarly, the audio outlet portion (208) can also include one or more outlet openings, or slits (2404a)-(2404e) (FIG. 24A).

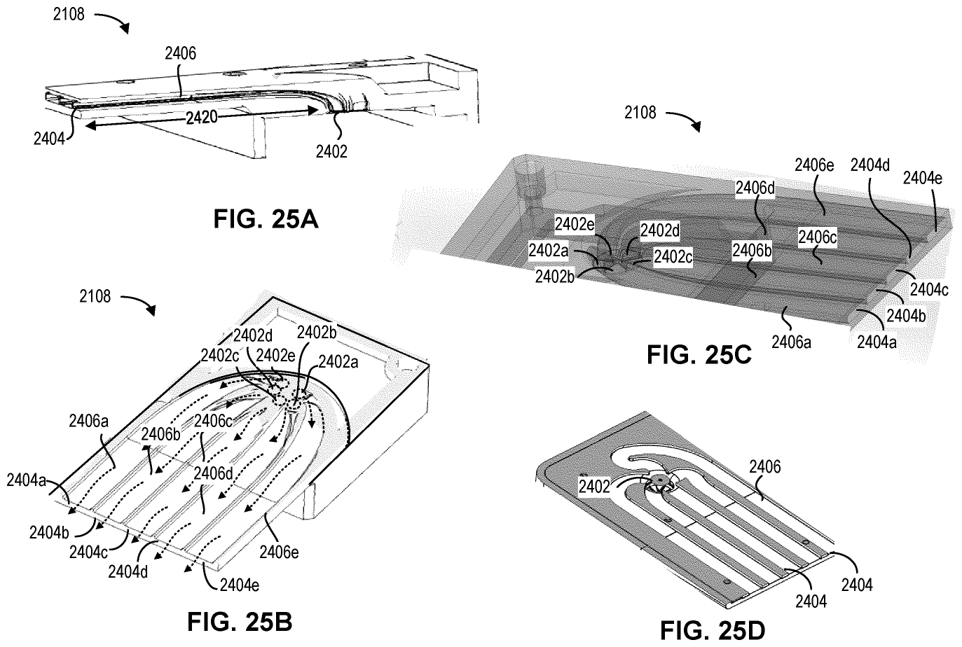

As exemplified in FIGS. 25A-25C, each of the inlet openings (2402a)-(2402e) communicates with a respective outlet opening (2404a)-(2404e). This communication is achieved through acoustic waveguide channels (2406a)-(2406e) that extend through the waveguide member (2008), and connect corresponding inlet and outlet openings (e.g., FIG. 25A). A waveguide channel length (2420) is defined, for each waveguide channel, between the respective inlet and outlet openings (2402), (2404) (FIG. 25A).

While the exemplified embodiment shows a single waveguide channel (2406) connecting a single inlet to a single outlet opening (2402), (2404)—other designs are also possible. For example, a waveguide channel (2406) can bifurcate to connect to two or more inlet and/or outlet openings (2402), (2404). It is also possible for waveguide channels (2406) to merge into a single waveguide channel, part way along the channel length (2420).

In an assembled state, the waveguide's audio inlet portion (2402) overlays (e.g., at least partially overlays) the audio outlet portion (2302b) of phase plug (2106) (FIGS. 22A-22B). For example, in FIGS. 22A and 22B the inlet and outlet portions (2302b), (2402) of the waveguide and phase plug members axially align, e.g., along axis (2150). In this manner, audio exiting the phase plug (2006) continues to travel through the waveguide member (2008). The audio then exits from the waveguide member's audio outlet portion (208).

As explained above, phase plug (2106) functions to compress sound energy of the audio. Accordingly, audio exiting the phase plug (2106) is audio having a compressed energy state. Waveguide member (2108) accordingly receives the compressed audio exiting the phase plug (2106).

In at least one example, the waveguide (2108) is designed to maintain the audio in a similar compressed or pressurized energy state, as the audio travels through the waveguide (2108). That is, waveguide (2108) may be designed to prevent the audio from substantially expanding into an uncompressed energy state. The appreciated benefits of this are discussed below.

To maintain the audio in the compressed or pressurized state, the waveguide's audio inlet portion (2402) may have similar design and/or dimensions as the phase plug's audio outlet portion (2302b).

For example, in FIG. 24C, the waveguide's inlet portion (2402) may have a circular shape, with a diameter substantially equal to the diameter (2304b) of the outlet portion (2302b), of phase plug (2006) (FIG. 23D).

Inside the waveguide member (2106), each waveguide channel (2406) may further maintain the audio in the compressed, or pressurized energy state. Compressed audio travels through the waveguide channels (2406), and exits from an outlet opening (2404).

In this design, each waveguide outlet opening (2404) acts as a three-dimensional (3D) point source. Concentrated sound energy exits the outlet slit opening (2404), and quickly expands omni-directionally since the acoustic wave diffraction at the small openings causes the sound energy to radiate out in a nearly spherical pattern.

In some examples, each waveguide output opening (2404) can be stylized as (but not limited to) a 2 mm slit in width. In some examples, each opening (2404) has a width between 1 mm to 1500 mm. Further, each waveguide member may have a length (2420) of approximately 1 inch or greater (e.g., a few meters).

In some examples, the use of a plurality of waveguide channels (2406)—and in turn, a plurality of audio input and output openings (2402), (2404)—ensures that each waveguide channel (2406) has a smaller cross-sectional area that maintains the audio energy in the compressed state. In some examples, each waveguide channel (2406) can have a substantially uniform cross-sectional area along its length, e.g., to maintain the compressed audio energy level.

In this manner, waveguide channels (2406) effectively function to convey compressed audio—from phase plug (2106)—to the waveguide outlet openings (2404), and over extended distances.

More particularly, the exemplified design allows the waveguide member (2108) to be used for various applications. For instance, in FIGS. 2B and 2C, the loudspeaker cabinet (2110) (FIG. 22)—retaining speaker driver (2102)—can be positioned behind the television (106). Further, waveguide channels (2406) can curve over or around the television (106), to carry the compressed audio, Output openings (208) are then positioned on-top of the television, to direct audio to the listener.

More broadly, the waveguide channels (2406) allow positioning the speaker driver (2102) at extended distances from the desired location of the outlet openings (2404).

It will be appreciated that transforming and maintaining audio in a compressed state facilitates conveying audio over longer distances, as well as conveying the audio along waveguide paths that may turn and bend (e.g., around objects).

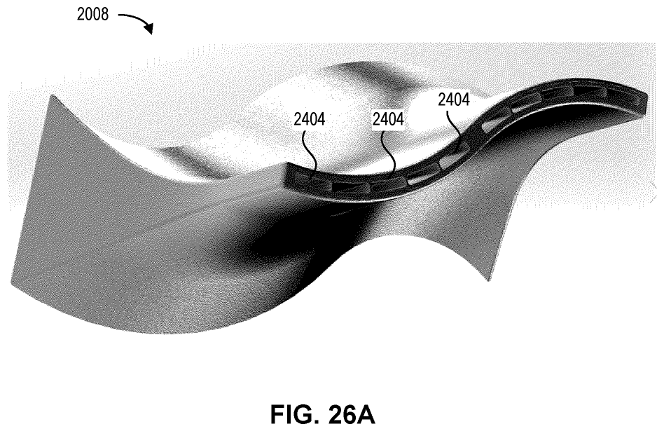

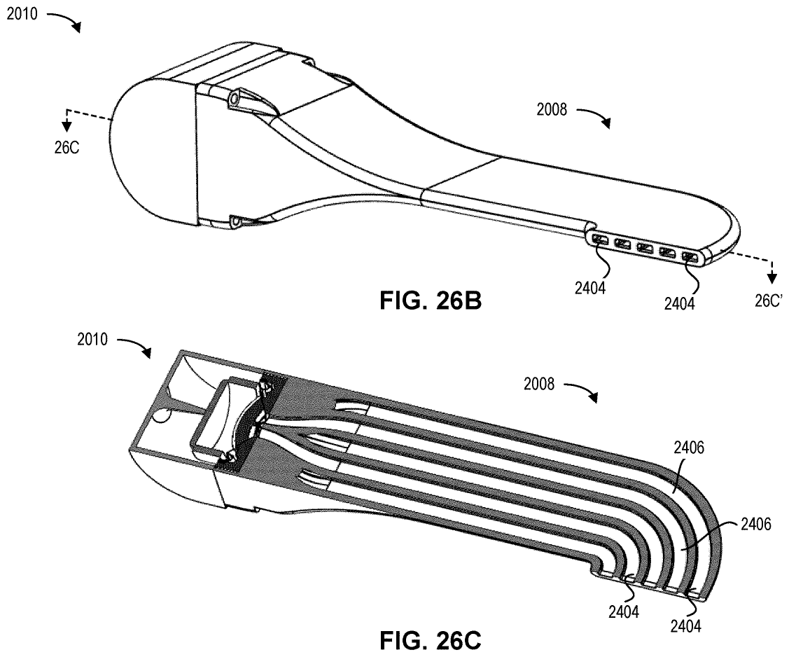

To that end, each waveguide channel (2406) can have any desired shape, design or configuration. For example, while the exemplified embodiment shows each waveguide channel (2406) as having an equal length (2420) (FIG. 25A), this is not necessarily the case. For example, as shown in FIGS. 26A-26C, different waveguide channels (2406) may have different lengths (2420). For instance, it may be desired to have some channels (2406) extend further than other channels (2406) to emit audio at a more distal point. In other examples, as shown in FIG. 25D, different waveguide guide channels (2406) may have different lengths and/or shapes based on the desired emitted frequency distribution through each waveguide channel (2406) (e.g., for smoothing the output frequency response).

Further, while each waveguide channel (2406) is shown as having a curved portion followed by a linear horizontal portion (FIG. 25A), other designs are possible. For instance, one waveguide channel (2406) may extended vertically or at an angle, rather than horizontally. Otherwise, waveguide channels (2406) may curve or bend in different manners (see e.g., FIG. 26C). Curved or bending designs may allow the micro-aperture (2010) to be used in applications where the module needs to bend, e.g., around corners.

In some examples, the length and design configuration of a waveguide channel (2406) is selected with a view to desired frequency tuning parameters.

In the exemplified embodiment, the output slit openings (2404) are arranged in a linear row, and spaced equally distally. However, other arrangement configurations are also possible for the openings (2404). For instance, in FIG. 26A, the output openings (2404) may have a curved or wavy arrangement configuration. In other examples, the arrangement configuration can be a cross or “+” sign. Additionally, the spacing between adjacent output slit openings (2404) may not be necessarily equidistant.

In at least one example, the arrangement configuration for the output openings (2404) is selected with a view to a desired interaction between the audio emitted by the different output openings (2404). For example, different arrangement configurations can result in different constructive and deconstructive interference sound patterns.

Other properties and attributes of the waveguide member (2008) can also be modified to achieve different sound properties. For example, this includes: (i) the number of input and/or output openings (2402), (2404); as well as (ii) the cross-sectional area or size of different input and/or output openings (2402), (2404).

In some examples, waveguide member (2008) can be concurrently used as a light pipe for decorative or illumination lighting. For example, the waveguide can be lit up, and the lighting visible on the output of the waveguide or speaker.

### (V.iii) Example Mounting Bracket for Loudspeaker Assembly

FIGS. 30C-30D exemplify a mounting bracket (3060) for mounting the loudspeaker assembly (204), e.g., behind television sets.

As shown, loudspeaker assembly (204) is coupled to the mounting bracket (3060), which itself can be coupled to a mounting structure (e.g., a wall).

Mounting bracket (3060) includes one or more adjustment elements (3062), (3064). In some examples, in an upright position, adjustment elements (3062), (3064) are used to manually adjust the vertical height of assembly (204), as well as moving the assembly (204) forwardly and rearwardly. In turn, this facilitates proper alignment of the loudspeaker assembly (204) behind, e.g., a television set. In at least one example, the adjustment elements (3062), (3064) comprise rotating knobs.

As shown in FIG. 30D, the mounting bracket (3060) includes one or more mechanical translation mechanisms (3058), which effect adjustments. The loudspeaker assembly (204) is coupled to the mechanical translation mechanisms (3058). Each translation mechanism (3058) can include a plurality of gears, forming rack and pinion systems.

For instance, vertical-translating knob (3062) can translate the loudspeaker assembly (204) vertically up-and-down. Rotation of knob (3062) causes primary gear (3066)—in translation mechanism (3058)—to rotate, which in turn, rotates a secondary gear (3068). Secondary gear (3068) interacts with rack (3062), which is coupled to moving member (3063) and translates the assembly (204) up-and-down.

Similarly, horizontal-translating knob (3064) translates the loudspeaker assembly (204) forwardly-and-rearwardly. In particular, rotation of knob (3064) causes rotation of primary gear (3074), which in turn rotates secondary gears (3076a), (3076b). Secondary gear (3076b) rotates tertiary gear (3078), which itself interacts with a rack (3078). Rack (3078) couples to the loudspeaker assembly (204) and translates the assembly (204) forwardly-and-rearwardly.

In some examples, gears (3076)—(3078), as well as rack (3080), are mounted to the moving member (3063). This allows the gears and rack to move up-and-down, with moving member (3063).

### VI. Example Coupling Mechanism in Audio Speaker System

As noted earlier, the subwoofer assembly (202) and loudspeaker assembly (204) can be coupled to form an integrated audio speaker system (150). Any coupling mechanism known in the art can be used to couple the assemblies together.

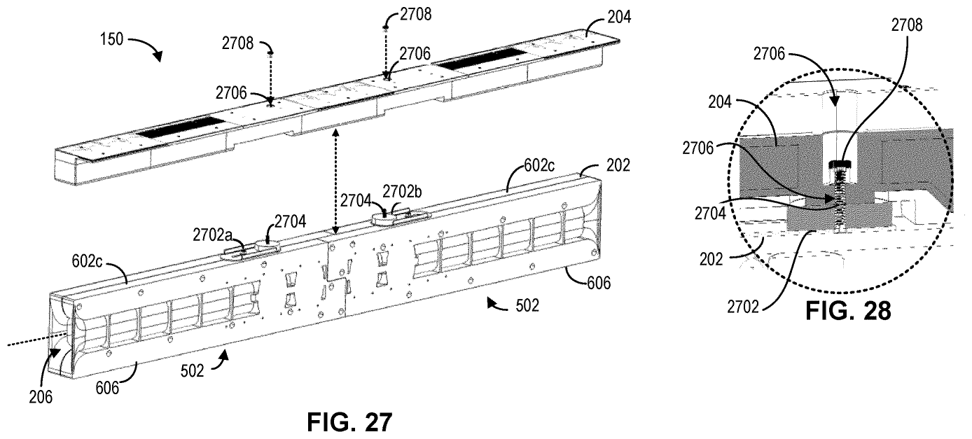

FIGS. 27-28 exemplify one configuration for a coupling mechanism. In this example, the coupling mechanism include one or more coupling brackets (2702a), (2702b).

Coupling brackets (2702) are disposed on the subwoofer assembly (202). For example, the coupling brackets (2702) are disposed over the top enclosure surface (606c), of each subwoofer module (502).

Each coupling bracket (2702) can include a bolt (2704). Bolt (2704) is received through a through-hole (2706), formed within the loudspeaker assembly (204) (FIG. 28). Once the bolt (2704) is inserted into the through-hole (2706)—a fastener (2708) is placed through the other end of the through-hole (2706), and tightened to the bolt (2704). In this manner, the loudspeaker assembly (204) is secured to the subwoofer assembly (202).

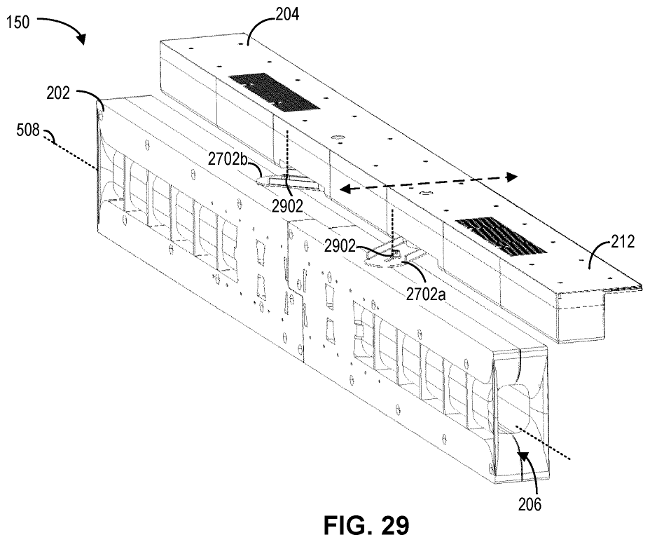

In some examples, the coupling mechanism is a rotatable mechanism. For example, as shown in FIG. 29, the coupling brackets (2702) can rotate about an axis orthogonal to the longitudinal axis (508).

An advantage of this configuration is that the loudspeaker assembly (204) can translate relative to the subwoofer assembly (202). For example, if the audio system (150) is mounted behind a television, it may be desirable to translate the loudspeaker assembly (204) forward such that the overhang portion (212) rests directly over the television.

The rotation mechanism can be achieved in any manner. In the illustrated embodiment, the coupling brackets (2702) are secured to the subwoofer enclosure via rotating fasteners (2902).

To that end, any combination of subwoofer assembly (202) and loudspeaker assembly (204) can be coupled using the coupling mechanism.

For example, this includes coupling the subwoofer assembly (202) of FIGS. 5-13 with the loudspeaker assembly (204) of FIGS. 20-26 (see e.g., FIG. 2).

It can also involve coupling the subwoofer assembly (202) of FIGS. 5-13 with an elongated loudspeaker assembly (204) having a more conventional design (FIGS. 3-4). This design can include normal output ports (212), and may include up-firing speakers (FIG. 4).

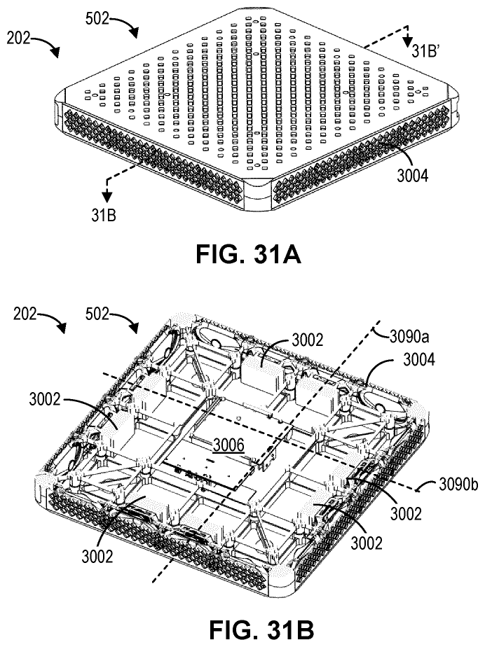

To that end, FIGS. 31A-31B exemplify a modification to a more conventional design for a subwoofer assembly (202). The exemplified design is characterized by a low-profile (e.g., a height of 2-3″) rectangular design. The low-profile design allows the subwoofer to be disposed in low height environments (e.g., underneath a couch).

The inside of the assembly (202) defines a cavity (3006) which retains a plurality of active and/or passive speaker drivers (3002). The speaker drivers (3002) are oriented to face away from the cavity (3002), and towards the outer casing (3004) to emit sound. In at least one example, the speaker drivers (3002) are positioned along the entire perimeter of the cavity (3006) to provide 360° sound.

In some examples, each pair of speaker drivers (3002) is aligned along a common axis (3090a), (3090b), which is orthogonal to a vertical axis. This opposite alignment allows for each pair of drivers to cancel the vibration caused by the other driver.

### VII. Interpretation

Various apparatuses, methods and compositions have been described herein to provide an example of an embodiment of each claimed invention. No embodiment described below limits any claimed invention and any claimed invention may cover apparatuses and methods that differ from those described herein. The claimed inventions are not limited to apparatuses, methods and compositions having all of the features of any one apparatus, method or composition described below or to features common to multiple or all of the apparatuses, methods or compositions described below. It is possible that an apparatus, method or composition described below is not an embodiment of any claimed invention. Any invention disclosed in an apparatus, method or composition described herein that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

The terms “an embodiment”, “embodiment”, “embodiments”, “the embodiment” “the embodiments”, “one or more embodiments” “some embodiments”, and “one embodiment” mean “one or more (but not all) embodiments of the present invention(s)”, unless expressly specified otherwise.

The terms “including”, “comprising”, and variations thereof mean “including but not limited to”, unless expressly specified otherwise. A listing of items does not imply that any or all of the items are mutually exclusive, unless expressly specified otherwise. The terms “a”, “an”, and “the” mean “one or more”, unless expressly specified otherwise.

As used herein and in the claims, two or more parts are said to be “coupled”, “connected”, “attached”, “joined”, “affixed”, or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, “directly joined”, “directly affixed”, or “directly fastened” where the parts are connected in physical contact with each other. As used herein, two or more parts are said to be “rigidly coupled”, “rigidly connected”, “rigidly attached”, “rigidly joined”, “rigidly affixed”, or “rigidly fastened” where the parts are coupled so as to move as one while maintaining a constant orientation relative to each other. None of the terms “coupled”, “connected”, “attached”, “joined”, “affixed”, and “fastened” distinguish the manner in which two or more parts are joined together.

Further, although any method steps may be described (in the disclosure and/or in the claims) in a sequential order, such methods may be configured to work in alternate orders. In other words, any sequence or order of steps that may be described does not necessarily indicate a requirement that the steps be performed in that order. The steps of methods described herein may be performed in any order that is practical. Further, some steps may be performed simultaneously.

As used herein and in the claims, a group of elements are said to ‘collectively’ perform an act where that act is performed by any one of the elements in the group, or performed cooperatively by two or more (or all) elements in the group.

Some elements herein may be identified by a part number, which is composed of a base number followed by an alphabetical or subscript-numerical suffix (e.g., 112a, or 112₁). Multiple elements herein may be identified by part numbers that share a base number in common and that differ by their suffixes (e.g., 112₁, 112₂, and 112₃). All elements with a common base number may be referred to collectively or generically using the base number without a suffix (e.g., 112).

1-47. (canceled)

48. A subwoofer module comprising:
a enclosure extending between a first enclosure end and a second enclosure end, wherein the first enclosure end defines an audio outlet opening;
an extended port defined within a port chamber wall extending within the enclosure,
the extended port extending along a port length dimension between a first port end and at least one second port end, the first port end is an open end defining the audio outlet opening;
at least one elongate cabinet located within the enclosure, and extending parallel to the extended port, for at least a portion of a length of the cabinet;
one or more driver-receiving openings adapted to receive one or more speaker drivers, wherein the driver-receiving openings are formed in the port chamber wall, and extend between the port and the at least one elongate cabinet.

49. The module of claim 48, wherein the one or more driver-receiving openings receive one or more of a woofer or a subwoofer driver.

50. The module of claim 48, wherein the at least one elongate cabinet comprises two elongate cabinets located around the port chamber wall.

51. The module of claim 49, wherein the at least one elongate cabinet comprises two elongate cabinets located around the port chamber wall.

52. The module of claim 50 or 51, wherein the one or more driver-receiving openings comprise a first and a second driver-receiving opening, wherein,
the first driver-receiving opening is located in the port chamber wall, and extends between the port and a first elongate cabinet, and
the second driver-receiving opening is located in the port chamber wall, and extends between the port and a second elongate cabinet.

53. The module of claim 48, wherein the subwoofer module is connectable to one or more other subwoofer modules to form a subwoofer assembly.

54. The module of claim 53, wherein the subwoofer module is connected to another subwoofer module at the second enclosure end such that the audio outlet openings, of each subwoofer module, are directed in opposing directions along a longitudinal axis.

55. A subwoofer assembly comprising one or more subwoofer modules defined according to claim 48.

56. A loudspeaker driver comprising:
a housing extending between a first housing end and a second housing end, wherein the first housing end comprises an audio outlet opening;
an elongated chamber defined within the housing, and extending along an extension axis between a first chamber end and a second chamber end, the first chamber end defining the audio outlet opening; and
a translating member that translates within the elongated chamber along extension axis between an extended position and a retracted position.

57. The driver of claim 56, wherein,
in the extended position, the translating member translates in the direction of the first chamber end, along extension axis, and
in the retracted position, the translating member translates in the direction of the second chamber end, along extension axis.

58. The driver of claim 56, wherein an end of the translating member comprises a cap which translates through the first chamber end between the extended and retracted positions.

59. The driver of claim 57, wherein an end of the translating member comprises a cap which translates through the first chamber end between the extended and retracted positions.

60. The driver of claim 56, wherein the driver further comprises at least one support member connected to each of an inner surface of housing, and the translating member.

61. The driver of claim 56, wherein the loudspeaker driver is one of an active loudspeaker driver and a passive loudspeaker driver.

62. The driver of claim 61, wherein the loudspeaker driver comprises an active loudspeaker driver and the loudspeaker driver further comprises:
an extended housing portion for housing a magnet assembly;
a heatsink comprising one or more elongate axial fins coupling the housing to the extended housing portion,
wherein an axial opening separates the housing from the extended housing portion, and
wherein a portion of the translating member is coupled to, or surrounded by a voice coil.

63. A loudspeaker module comprising:
a phase plug member comprising an audio inlet portion and an audio outlet portion, the audio outlet portion having a small cross-sectional area than the audio inlet portion,
wherein the audio inlet portion is adapted to interface over an audio loudspeaker driver; and
a waveguide member comprising: (i) a waveguide audio inlet area, (ii) one or more audio outlet openings, and (iii) one or more acoustic waveguide channels connecting the audio inlet area to the one or more audio outlet openings,
wherein the waveguide audio inlet area interfaces over the audio outlet portion of the phase plug member, and
the waveguide inlet area and audio outlet portion have similar cross-sectional areas.

64. The module of claim 63, wherein,
the waveguide audio inlet area comprises a plurality of inlet openings,
the waveguide outlet openings comprise a plurality of outlet openings, and
a plurality of waveguide channels connect the plurality of inlet openings to the plurality outlet openings.

65. The module of claim 64, wherein the plurality of outlet openings are arranged in an arrangement configuration.

66. The module of claim 63, wherein the one or more waveguide channels have a constant cross-sectional area along a respective length of the channel.

67. The module of claim 63, further comprises a cabinet portion which at least partially receives a rear end of the loudspeaker driver.
